(19) United States
(12) Patent Application Publication
(10) Pub. No.: US 2026/0036264 A1
(43) Pub. Date: Feb. 5, 2026

(54) APPARATUSES OR SYSTEMS FOR REDUCING EMISSIONS FROM GAS STORAGE TANKS AND METHODS FOR MAKING AND USING SAME

(71) Applicants: Richard Anthony Nichols, Newport Beach, CA (US); Katherine Eline Obergfell, Newport Beach, CA (US)

(72) Inventors: Richard Anthony Nichols, Newport Beach, CA (US); Katherine Eline Obergfell, Newport Beach, CA (US)

(21) Appl. No.: 19/288,907

(22) Filed: Aug. 1, 2025

Related U.S. Application Data
(60) Provisional application No. 63/678,607, filed on Aug. 2, 2024.

(51) Int. Cl. F17D 3/12; F17D 1/04

(52) U.S. Cl. CPC F17D 3/12; F17D 1/04

(57) ABSTRACT

An apparatus for the storage and treatment of a vapor including two apparatuses or systems, one allows for the short term accumulation or storage of a vapor before it is processed or abated or used and the other adjusts an adjustable vapor composition using a liquid and an adjustment gas and when the combined together, the two apparatuses or systems provide a steady volumetric flow rate of an effluent or output vapor or vapor stream having the adjusted vapor composition.

### RELATED APPLICATIONS

This application claims the benefit and priority to U.S. Provisional Patent Application Ser. No. 63/678,607 filed Aug. 2, 2024 (2 Aug. 2024).

### BACKGROUND OF THE DISCLOSURE

### 1. Field of the Disclosure

Embodiments of the present disclosure relate to vapor storage and treating apparatuses or systems and methods implementing them.

In particular, embodiments of the present disclosure relate to vapor storage and treating apparatuses or systems and methods implementing them, the vapor storage and treating apparatuses or systems include a vapor storage assembly or subsystem and an integrated vapor concentration adjustment and treatment assembly or subsystem, wherein the apparatuses or systems and methods implementing them are designed to store a vapor and produce a controlled effluent or output vapor or vapor stream, which may have a controlled BTU per cubic foot heating value, an optimized BTU per cubic foot heating value, a controlled thermal incineration value, or a purified waste vapor effluent or output stream if the input vapor or vapor stream is a sour or contaminated input vapor or vapor stream. In certain embodiments, the integrated vapor treating apparatuses or systems include an abatement or incinerator assembly or subsystem. In other embodiments, the treated vapor is forwarded to a pipeline.

### 2. Description of the Related Art

Environmental regulations require the collection and abatement of hazardous and/or flammable vapors across a range of industries throughout the US. The operations that generate these vapors can be inconsistent in both the volume of vapors generated (cubic foot per minute, cfm) and the concentration of the of the target vapors.

One of the main ways to abate these types of vapors is through incineration or thermal destruction. Devices that abate in this manner are numerous. Examples of such devices are thermal oxidizers, incinerators, furnaces, vapor combustion units (VCU's), flares, boilers etc.

The destruction efficiency of each device for a specific hazardous or flammable vapor depends on many factors. Two of the most important factors are the vapor volumetric flow rate of the target vapor coming into the device and the concentration of the hazardous or flammable vapor.

The larger the variability in the incoming vapor volume and/or the vapor concentration of the vapor to be abated, the less efficient the abatement device is likely to be.

While there are several solutions for controlling emissions from bulk gasoline distribution plants, there is still a need in the art for other or different apparatuses, systems, and methods for controlling emissions from bulk gasoline distribution plants, especially apparatuses, systems, and methods utilizing vapor bladder assemblies or subsystems and vapor composition adjusting or treating assemblies or subsystems to adjust a composition of the vapor for a specific purpose and to control a vapor output flow rate either to an abatement assembly or subsystem or to a pipeline. In particular, the apparatuses, systems, and methods utilizing vapor bladder assemblies or subsystems and vapor composition adjusting or treating assemblies or subsystems designed to produce a steady state vapor output from any vapor generating process such as gasoline loading racks that operates or produces vapor on a batch or periodic basis.

### SUMMARY OF THE DISCLOSURE

### Apparatuses

Embodiments of this disclosure provide vapor storage and treating apparatuses include: (1) a vapor storage assembly and (2) an integrated vapor concentration adjustment and treatment assembly including: (a) an adjustable membrane assembly disposed in an interior of a vapor storage tank and configured to adjust to a volume of the vapor in the vapor storage tank; (b) a vapor treating assembly disposed in and on a lower portion of the vapor storage tank and configured to adjust a vapor composition of the vapor in the vapor storage tank; (c1) a blower and sensor assembly or (c2) a pipeline introduction and sensor assembly; and (d) an integrated vapor treating control assembly. The apparatuses are designed to store a vapor and produce a controlled effluent or output vapor or vapor stream having a controlled flow rate or a controlled volume per minute output. The effluent or output vapor or vapor stream may have a controlled BTU per cubic foot heating value, an optimized BTU per cubic foot heating value, a controlled thermal incineration value, or a purified waste vapor effluent or output stream if the input vapor or vapor stream is a sour or contaminated input vapor or vapor stream and it to be provided to a pipeline distribution system.

Embodiments of this disclosure provide integrated vapor concentration adjustment and treatment apparatuses including: (a) an adjustable membrane assembly disposed in an interior of a vapor storage tank and configured to adjust to a volume of the vapor in the vapor storage tank; (b) a vapor treating assembly disposed in and on a lower portion of the vapor storage tank and configured to adjust a vapor composition of the vapor in the vapor storage tank; (c1) a blower and sensor assembly or (c2) a pipeline introduction and sensor assembly; and (d) an integrated vapor treating control assembly. The apparatuses are designed to store a vapor and produce a controlled effluent or output vapor or vapor stream having a controlled flow rate or a controlled volume per minute output. The effluent or output vapor or vapor stream may have a controlled BTU per cubic foot heating value, an optimized BTU per cubic foot heating value, a controlled thermal incineration value, or a purified waste vapor output stream if the input vapor or vapor stream is a sour or contaminated input vapor or vapor stream and it to be provided to a pipeline distribution system.

In certain embodiments, the vapor storage and treating apparatuses further include (e1) an abatement or incineration assembly. In other embodiments, the vapor storage and treating apparatuses further include (e2) a pipeline introduction and sensor assembly or (e3) any other vapor abatement or processing unit/system.

### Systems

Embodiments of this disclosure provide vapor storage and treating systems include: (1) a vapor storage subsystem and (2) an integrated vapor concentration adjustment and treatment subsystem including: (a) an adjustable membrane subsystem disposed in an interior of a vapor storage tank and configured to adjust to a volume of the vapor in the vapor storage tank; (b) a vapor treating subsystem disposed in and on a lower portion of the vapor storage tank and configured to adjust a vapor composition of the vapor in the vapor storage tank; (c1) a blower and sensor subsystem or (c2) a pipeline introduction and sensor subsystem; and (d) an integrated vapor treating control subsystem. The systems are designed to store a vapor and produce a controlled effluent or output vapor or vapor stream having a controlled flow rate or a controlled volume per minute output. The effluent or output vapor or vapor stream may have a controlled BTU per cubic foot heating value, an optimized BTU per cubic foot heating value, a controlled thermal incineration value, or a purified waste vapor output stream if the input vapor or vapor stream is a sour or contaminated input vapor or vapor stream and it to be provided to a pipeline distribution system.

Embodiments of this disclosure provide integrated vapor concentration adjustment and treatment systems including: (a) an adjustable membrane subsystem disposed in an interior of a vapor storage tank and configured to adjust to a volume of the vapor in the vapor storage tank; (b) a vapor treating subsystem disposed in and on a lower portion of the vapor storage tank and configured to adjust a vapor composition of the vapor in the vapor storage tank; (c1) a blower and sensor subsystem or (c2) a pipeline introduction and sensor subsystem; and (d) an integrated vapor treating control subsystem. The subsystem are designed to store a vapor and produce a controlled effluent or output vapor or vapor stream having a controlled flow rate or a controlled volume per minute output. The effluent or output vapor or vapor stream may have a controlled BTU per cubic foot heating value, an optimized BTU per cubic foot heating value, a controlled thermal incineration value, or a purified waste vapor output stream if the input vapor or vapor stream is a sour or contaminated input vapor or vapor stream and it to be provided to a pipeline distribution system.

In certain embodiments, the vapor storage and treating apparatuses further include (e1) an abatement or incineration subsystem. In other embodiments, the vapor storage and treating apparatuses further include (e2) a pipeline introduction and sensor subsystem or (e3) any other vapor abatement or processing unit/system.

### Methods for Making and Using Same

Embodiments of this disclosure provide methods including:
(a) installing an integrated vapor concentration adjustment apparatus or system into a tank of a vapor storage assembly or subsystem, and
   (b) installing an integrated vapor treating control assembly.

Embodiments of this disclosure provide methods including:
(a) filling a lower section of the tank with a liquid from a liquid source;
   (b) filling a vapor storage tank of a vapor storage assembly with a vapor from a vapor source;
   (c) as the vapor storage tank is being filled with the vapor, simultaneously adjusting a gas storage assembly disposed in an interior of the vapor storage tank;
   (d) withdrawing the liquid from the lower section of the vapor storage tank;
   (e) injecting the withdrawn liquid into the vapor in the vapor storage tank, simultaneously or sequentially injecting an adjustment gas from an adjustment gas source into the vapor storage tank, and optionally simultaneously or sequentially injecting one or more vapor purifying materials from a vapor purifying material source into the vapor storage tank to form an effluent or output vapor having a desired effluent or output vapor composition; and
   (f) supplying the effluent or output vapor or vapor stream either to an abatement or incineration assembly or subsystem at a controlled pressure and flow rate or to a pipeline introduction and sensor assembly at a controlled temperature, pressure, and flow rate or any other vapor abatement or processing unit/system.

### BRIEF DESCRIPTION OF THE DRAWINGS OF THE DISCLOSURE

The disclosure may be better understood with reference to the following detailed description together with the appended illustrative drawings in which like elements are numbered the same:

FIG. 1A depicts an embodiment of an apparatus or system of this disclosure.

FIG. 1B depicts another embodiment of an apparatus or system of this disclosure.

FIG. 1C depicts another embodiment of an apparatus or system of this disclosure.

FIG. 1D depicts another embodiment of an apparatus or system of this disclosure.

FIG. 1E depicts another embodiment of an apparatus or system of this disclosure.

FIG. 1F depicts another embodiment of an apparatus or system of this disclosure.

FIG. 1G depicts another embodiment of an apparatus or system of this disclosure.

FIG. 2A depicts an embodiment of an integrated abatement apparatus or system of this disclosure.

FIG. 2B depicts another embodiment of an integrated abatement apparatus or system of this disclosure.

FIG. 2C depicts another embodiment of an integrated abatement apparatus or system of this disclosure.

FIG. 2D depicts another embodiment of an integrated abatement apparatus or system of this disclosure.

### DEFINITIONS USED IN THE DISCLOSURE

The term “at least one” means one or more or one or a plurality, additionally, these three terms may be used interchangeably within this application. For example, at least one device means one or more devices or one device and a plurality of devices.

The term “one or a plurality” means one item or a plurality of items.

The term “about” means that a value of a given quantity is within ±20% of the stated value. In other embodiments, the value is within ±15% of the stated value. In other embodiments, the value is within ±10% of the stated value. In other embodiments, the value is within ±5% of the stated value. In other embodiments, the value is within ±2.5% of the stated value. In other embodiments, the value is within ±1% of the stated value.

The term “substantially” means that a value of a given quantity is within ±5% of the stated value. In other embodiments, the value is within ±2.5% of the stated value. In other embodiments, the value is within ±2% of the stated value. In other embodiments, the value is within ±1% of the stated value. In other embodiments, the value is within ±0.1% of the stated value.

In this disclosure, every range of values (e.g., “from about x to about y” or “from approximately x to y” or “from approximately x-y” or “between about x and about y” or “between approximate x and y” or “between approximately x-y) is to be understood as referring to the ranges including end points and all subranges between x and y, e.g., between about X and Y includes all ranges x and y, where x is greater than X and y is less than Y.

### DETAILED DESCRIPTION OF THE DISCLOSURE

The inventors have also found that vapor storage and treating apparatuses or systems may be constructed and methods implementing them for producing a steady-state effluent or output vapor or vapor stream having a desired effluent or output composition and a controlled steady-state output flow rate. The vapor storage and treating apparatuses or systems include: (1) a vapor storage assembly or subsystem and (2) an integrated vapor concentration adjustment and treatment assembly or subsystem including: (a) an adjustable membrane assembly or subsystem disposed in an interior of a vapor storage tank and configured to adjust to a volume of the vapor in the vapor storage tank; (b) a vapor treating assembly or subsystem disposed in and on a lower portion of the vapor storage tank and configured to adjust a vapor composition of the vapor in the vapor storage tank; (c1) a blower and sensor assembly or subsystem or (c2) a pipeline introduction and sensor assembly or subsystem; and (d) an integrated vapor treating control assembly or subsystem.

In certain embodiments, the vapor storage and treating apparatuses or systems further include a vapor abatement or incineration assembly or subsystem in vapor communication with the blower and sensor assembly or subsystem for incinerating the effluent or output vapor or vapor stream.

In other embodiments, the vapor storage and treating apparatuses or systems further include a pipeline introduction and sensor assembly or subsystem in vapor communication with a pipeline and configured to introduce the effluent or output vapor or vapor stream into the pipeline carrying the same vapor composition as the effluent or output vapor composition. For example, if the input vapor or vapor stream comprises a contaminated fuel such as methane, then the integrated vapor concentration adjustment and treatment apparatuses or systems may further include a scavenging agent introduction assembly or subsystem configured to introduce scavenging agents into the liquid to remove contaminates in contaminated fuel and a contaminate removal assembly or subsystem for removing the scavenged contaminates from the liquid on a continual or periodic basis.

The adjustable membrane assembly or subsystem may include, without limitation, balloon type bladders, hemispherical weighted ring supported membrane type bladders, conical weighted ring supported membrane type bladders, or any other type of vapor adjustable bladder.

The integrated vapor concentration adjustment and treatment apparatuses or systems are designed or configured to adjust a composition of the vapor in the vapor storage tank to a desired effluent or output vapor composition. In certain embodiments, the integrated vapor concentration adjustment and treatment apparatuses or systems may also be designed or configured to control a liquid recirculation flow rate and an adjustment gas flow rate to produce the effluent or output vapor composition based on data received either from (a) thermal efficiency sensors associated with the vapor abatement or incineration assembly or subsystem or vapor composition sensors associated with the vapor abatement or incineration assembly or subsystem and/or the a blower and sensor assembly or subsystem or (b) sensors associated with a pipeline introduction and sensor assembly or subsystem. The flow rates are all controlled by the integrated vapor treating control assembly or subsystem.

In certain embodiments, the integrated vapor concentration adjustment and treatment apparatuses or systems or assemblies and subsystems may also be designed to produce a steady state volumetric output vapor flow rate from a variable volume storage space within the storage tank and a variable amount of input vapor entering the storage tank.

Again, the adjustable membrane assembly or subsystem comprises a flexible membrane, member, or bladder disposed inside a storage tank, which rises and falls based on the overall vapor volume or flow rate into and out of the storage tank. If the vapor flow rate into the storage tank is greater than the output vapor flow rate, then the flexible membrane, member, or bladder will rise or deflate. If the output vapor flow rate out of the device is greater than incoming vapor flow rate, then the flexible membrane, member, or bladder will fall or inflate. The overall size and volume capacity of the integrated gas storage and vapor treatment assembly or subsystem are custom engineered and sized based on the amount of vapor generated on-site that needs to be abated and a speed (which may be optimized) of a vapor blower of the integrated gas storage and vapor treatment assembly or subsystem feeding the vapor abatement or incineration assembly or subsystem at its most efficient setting or a pressure and temperature of the effluent or output vapor sufficient to be introduced into a given pipeline.

In certain embodiments, the integrated vapor concentration adjustment and treatment apparatuses or systems or assemblies and subsystems may also be designed to provide a steady effluent or output vapor having a desired composition such as a desired BTU per cubic feet heating value. The integrated vapor concentration adjustment and treatment apparatuses or systems or assemblies and subsystems use two different methods for achieving this goal; one method comprises an adjustable membrane assembly or subsystem, which adjusts to the volume of vapor in the vapor storage tank and one method comprises an integrated vapor concentration adjustment and treatment assembly or subsystem, which adjusts a composition of the vapor in the vapor storage tank using an external liquid supplied from an external liquid source and an eternal adjustment gas supplied from an eternal adjustment gas source.

The external liquid is introduced into the lower section or portion of the vapor storage tank called the “heel during startup to a desired internal liquid fill level, and the external adjustment gas is introduced into the heel of the vapor storage tank, wherein the external liquid and adjustment gas are introduced at a rate to adjust the vapor composition to any desired composition. For example, the stable desired vapor output composition may comprise a vapor output composition having a desired BTU per cubic foot heating value via a circulating stream of internal flammable liquid and an injection rate of the flammable adjustment gas. The liquid from the heel is pumped up to a vapor space in the tank either under the vapor storage assembly or subsystem or surrounding the flexible bladder and is injected into the vapor in the vapor space via an injection assembly or subsystem. The liquid injection assembly or subsystem may include any device designed to produce a stream of liquid or atomized droplets. Such devices include, without limitation, one or more nozzles, one or more atomizers, one or more sprayers, any other type of device for forming a liquid spray, a liquid atomized spray, or a stream of liquid droplets, or any combination thereof. The stream of liquid droplets or atomized liquid particles is designed to envelop an incoming vapor or vapor stream as well as the vapor in the surrounding vapor space inside the tank. The stream of liquid droplets may increase or saturate the incoming vapor or vapor stream increasing its heating valve or BTU per cubic foot heating value. Conversely, fully saturated vapor may have its vapor concentration decreased or absorbed by the stream of liquid droplets. Thus, lowering or reducing its BTU per cubic foot heating value. By controlling the liquid content in the heel/lower portion of the tank and a velocity and a pressure of the stream of liquid droplets being introduced into the vapor and the rate of introduction of the adjustment gas, the effluent or output vapor or vapor stream existing the tank may have any desired output composition such as a BTU per cubic foot heating value range for efficient destruction ine the vapor abatement or incineration assembly.

The integrated vapor concentration adjustment and treatment apparatuses or systems or assemblies and subsystems may also saturate incoming vapor using an external gas source such as natural gas or propane. In certain embodiments, a ring may be installed around the circumference of the tank with small holes drilled in it. Gas is supplied to the ring in an amount required to increase a BTU per cubic foot heating value of the effluent or output vapor to the desired value.

Embodiments of the integrated gas storage and vapor treatment control assembly or subsystem may directly measure a BTU content value of the effluent vapor exiting the tank, while other embodiments, measure an operating temperature of an abatement device of the vapor abatement or incineration assembly or subsystem and/or an amount of combustion air provided to the abatement device of the vapor abatement or incineration assembly or subsystem, eliminating the need to measure of the effluent BTU value in the tank.

In certain embodiments, as a volume of vapor in the vapor storage tank changes, a volume of gas in the adjustable membrane assembly or subsystem changes. Generally, the adjustable membrane assembly or subsystem comprises a bladder such as a balloon type bladder, a ring type flexible membrane bladder, or any other type of bladder system. For example, if vapor is added to the vapor storage tank, then the bladder vents air or gas to the atmosphere, if vapor is withdrawn from the vapor storage tank, then air or gas is added to the bladder either from the atmosphere if the gas is air or from a gas source if the gas is a non-flammable gas, or during a diurnal cycle, adjusting the gas in the bladder as the volume of vapor changes in the vapor storage tank. This should be removed. Air or gas would only be added to the bladder to pressurize the vapor space of the tank as described below.

In other embodiments, the vapor storage assembly or subsystem further includes a compressor for increasing a pressure of the vapor or gas within the tank. In other embodiments, the vapor storage assembly or subsystem fills or vents air to and from the atmosphere. In other embodiments, the vapor storage assembly or subsystem fills or vents air, a non-flammable gas such as nitrogen, carbon dioxide, argon, freon, any other non-flammable gas, or any mixture thereof. In other embodiments, the bladder substantially maintains the vapor space within the fuel tank at atmospheric pressure or a higher pressure. In other embodiments, the vapor storage assembly or subsystem may further comprise a pressure relief valve and a vacuum relief valve for maintaining vapor pressure in the tank. In other embodiments, the bladder may be pressurized to increase a vapor pressure of the vapor in the vapor storage tank.

The bladder is preferably constructed of a durable substantially lightweight flexible material with a low permeability to a specific chemical vapor and that is stable long-term in the presence of that specific chemical in liquid or vapor form. The bladder may be vented outside the sealed tank by a vent of unitary construction with the bladder or the bladder may be connected to a separate vent system that exits outside the tank to maintain as set of working pressure.

As is known in the art, the tank may include a pressure relief valve and a vacuum relief valve to substantially prevent excessive pressure or vacuum from developing in the tank. The pressure relief valve opens if the tank pressure exceeds a high pressure limit, and the vacuum relief valve opens if the tank vacuum exceeds a low pressure limit. For example, if the tank was completely empty of vapor, and the volume of the bladder was not large enough to compensate for the entire vapor volume, then a vacuum would develop within the tank. If the vacuum became too large, the vacuum relief valve would open to equalize the pressure. A vacuum could also develop in the tank from a large decrease in temperature. At the other extreme, if the bladder was deflated, and the vapor was heated, pressure in the fuel tank would increase until the pressure relief valve opened to reduce the pressure.

Embodiments of the apparatuses or system and method implementing them as the vapor is withdrawn from the tank and abated or incinerated or supplied to a pipeline, the bladder begins to fill with air or an inert gas to replace the volume of the vapor being withdrawn. (Note: the decrease in vapor may be offset to some degree by increasing vapor being supplied to the tank or may adjusting the pressure and/or temperature of the vapor and/or the air or inert gas.) It is believed that this exchange of air between the atmosphere and the bladder substantially maintains the vapor space at atmospheric pressure and only air from the bladder may be vented from the tank because the air within the bladder is isolated from the vapor, thus substantially preventing vapor emissions. Additionally, the integrated gas storage and vapor treatment assembly or subsystem constantly adjusts that vapor composition based on output from sensors either detecting a composition of the vapor, detecting incineration efficiency, or detecting a BTU value of the vapor.

### Suitable Components for Use in the Disclosure

Suitable materials out of which the bladder of the vapor storage assembly or subsystem include, without limitation, a durable lightweight flexible material with a low permeability and long-term stability to the vapor being stored in the storage tank and its liquid, such as gasoline and gasoline vapor, diesel and diesel vapor, any other hydrocarbon liquid and its vapor, other liquids and their vapor, or mixtures or combination thereof.

Suitable vapors for use in this disclosure include, without limitation, hydrocarbon gases, contaminated hydrocarbon gases, hydrocarbon fuels, contaminated hydrocarbon fuels, other flammable gases, other contaminated flammable gases, non-flammable gases, contaminated non-flammable gases, or any other gas that need to be stored and properties modified or adjusted prior to subsequent use. Exemplary examples of flammable vapors for use in this disclosure include, without limitation, methane, contaminated methane, natural gas, contaminated natural gas, sour natural gas, ethane, contaminated ethane, propane, contaminated propane, other hydrocarbon fuels, or other contaminated hydrocarbon fuels, wherein the contaminated adjustments gases are cleaned in the tank using scavengers prior to subsequent use. Other exemplary examples flammable vapors for use in this disclosure include, without limitation, methane, natural gas, ethane, propane, gasoline, diesel, or other hydrocarbon fuels.

Suitable liquids for use in the liquid and vapor BTU optimizer assembly or subsystem include, without limitation, gasoline, diesel, methanol, ethanol, MTBE, benzene, toluene, other hydrocarbon liquids, any other liquid necessary for the treatment of the incoming vapor stream, or mixtures thereof.

Suitable adjustment gases for use in this disclosure include, without limitation, hydrocarbon gases, gaseous hydrocarbon fuels, other flammable gases, non-flammable gases, or mixtures thereof. Exemplary examples of adjustment gases for use in this disclosure include, without limitation, methane, natural gas, ethane, propane, or mixtures thereof, wherein the adjustment gases are designed to adjust the BTU or composition of the vapor stored in the storage tank. For non-flammable vapors, the adjustment gases are designed to adjust the composition of the non-flammable vapor prior to subsequent use.

Suitable gases for use in the vapor storage assembly or subsystem including, without limitation, air, a non-flammable gas such as nitrogen, carbon dioxide, argon, freon, any other non-flammable gas, or any mixture thereof.

Suitable scavengers or scavenging agents include, without limitation, sulfur scavengers or scavenging agents (i.e., scavengers or scavenging agents for hydrogen sulfide), hydrogen cyanide scavengers or scavenging agents, carbon dioxide scavengers or scavenging agents, any other scavengers or scavenging agents used to clean hydrocarbon gases such as methane, natural gas, or propane.

Suitable liquid pumps for use in this disclosure include, without limitation, axial type liquid pumps, mixed type liquid pumps, radial type liquid pumps, electromagnetic type liquid pumps, jet type liquid pumps, gear type liquid pumps, peristaltic type liquid pumps, rotary vane type liquid pumps, screw type liquid pumps, diaphragm type liquid pumps, piston/plunger type liquid pumps, or any other type pump capable pumping a liquid.

Suitable liquid flow control valves for use in this disclosure include, without limitation, (a) ball valves (Ball valves use a spherical disc to control flow. When the valve is open, the sphere allows for straight-through flow; when closed, the sphere is rotated to block flow.); (b) butterfly valves (butterfly valves use a rotating disc to regulate flow. When the disc is turned parallel to the flow, it allows for unrestricted flow; when turned perpendicular, it restricts flow.); (c) gate valves (Gate valves use a raised or lowered gate to control flow. When fully open, the gate allows for unobstructed flow; when closed, it forms a seal to stop flow.); (d) globe valves (Globe valves use a movable plug to adjust flow. When the plug is lifted, it allows flow; when lowered, it restricts flow by closing off the passage.); (c) diaphragm valves (Diaphragm valves use a flexible diaphragm to regulate flow. When the diaphragm is raised, it allows flow; when lowered, it closes off the passage to stop flow.); (f) piston valves (Piston valves use a piston within a cylinder to control flow. When the piston is in an open position, flow is allowed; when the piston is moved to close the passage, flow is stopped.), (g) any other type of flow control valve for controlling a liquid flow rate, or (h) combinations thereof.

Suitable gas flow control valves for use in this disclosure include, without limitation, ball valves, butterfly valves, gate valves, globe valves, diaphragm valves, piston valves, any other type of flow control valve for controlling a gas flow rate, or combinations thereof.

Suitable pressure sensors for use in this disclosure include, without limitation, aneroid barometer pressure sensors, manometer pressure sensors, bourdon tube pressure sensors, vacuum pressure sensors, sealed pressure sensors, piezoelectric pressure sensors, strain gauge pressure sensors, or any combination thereof.

Suitable temperature sensors for use in this disclosure include, without limitation, thermocouple devices, resistance temperature detection devices, thermistor devices, semiconductor-based IC devices, or any combination thereof.

Suitable composition sensors for use in this disclosure include, without limitation, potentiometric sensors, amperometric sensors, impedimetric sensors, or any combination thereof.

Suitable BTU sensors for use in this disclosure include, without limitation, mechanical heat meter sensors, heat meter using ultrasound sensors, electrical heat meter sensors, electrochemical gas sensor, catalytic gas sensor, infrared gas sensor, photoionization gas sensor. or any combination thereof.

Suitable liquid and/or gas level sensors for use in this disclosure include, without limitation, air bubbler level sensors, capacitive level sensors, differential pressure level sensors, electrical conductivity or resistance level sensors, mechanical or magnetic float level sensors, optical level sensors, pressure membrane level sensors, radar or microwave level sensors, radio frequency (RF) level sensors, sonic or ultrasonic level sensors, retractable tape level sensors, Hi-Hi switch level sensors, tuning fork level sensors, any other level sensor, or any combination thereof.

### Software Systems

Suitable software systems, software products, and/or software objects for use in this disclosure include, without limitation, any analog or digital processing unit or units having single or a plurality of software products installed thereon and where each software product has one or more adjustable attributes associated therewith, or singular software programs or systems with one or more adjustable attributes, menus, lists, or other functions, attributes, and/or characteristics, and/or display outputs. Exemplary examples of such software products include, without limitation, operating systems, graphics systems, business software systems, word processor systems, business systems, online merchandising, online merchandising systems, purchasing and business transaction systems, databases, software programs and applications, internet browsers, accounting systems, military systems, control systems, or mixtures or combinations thereof. Software objects generally refer to all components within a software system or product that are controllable by at least one processing unit.

### Processing Units

Suitable processing units for use in the present disclosure include, without limitation, programmable logic controllers (PLCs), human machine interface (HMIs), digital processing units (DPUs), analog processing units (APUs), Field Programmable Gate Arrays (FPGAs), any other technology that may receive motion sensor output and generate command and/or control functions for objects under the control of the processing unit, and/or mixtures and combinations thereof.

Suitable PLCs and HMIs for use in the present disclosure include, without limitation, General Electric (GE), Rockwell Automation, Siemens, Automation Direct, Fuji, Schneider Electric, ABB, Omron, Modicon, Mitsubishi, Red Lion.

Suitable digital processing units (DPUs) for use in this disclosure include, without limitation, any digital processing unit capable of accepting input from a plurality of devices and converting at least some of the input into output designed to select and/or control attributes of one or more of the devices. Exemplary examples of such DPUs include, without limitation, microprocessor, microcontrollers, or the like manufactured by Intel, Motorola, Ericsson, HP, Samsung, Hitachi, NRC, Applied Materials, AMD, Cyrix, Sun Microsystem, Philips, National Semiconductor, Qualcomm, or any other manufacture of microprocessors or microcontrollers, and/or mixtures or combinations thereof.

Suitable analog processing units (APUs) for use in this disclosure include, without limitation, any analog processing unit capable of accepting input from a plurality of devices and converting at least some of the input into output designed to control attributes of one or more of the devices. Such analog devices are available from manufacturers such as Analog Devices Inc.

### Input/Output Devices

Suitable input and output devices for use in this disclosure include, without limitation, cathode ray tubes, liquid crystal displays, light emitting diode displays, organic light emitting diode displays, plasma displays, touch screens, touch sensitive input/output devices, audio input/output devices, audio-visual input/output devices, holographic displays and environments, keyboard input devices, mouse input devices, optical input devices, eye-tracking devices, head-tracking devices, hand-tracking devices, body-tracking devices, any other input and/or output device that permits a user to receive user intended inputs and generated output signals, or any combination thereof.

### DETAILED DESCRIPTION OF THE DRAWINGS OF THE DISCLOSURE

### Vapor Treating and Incineration Embodiments Using a Balloon Type Bladder

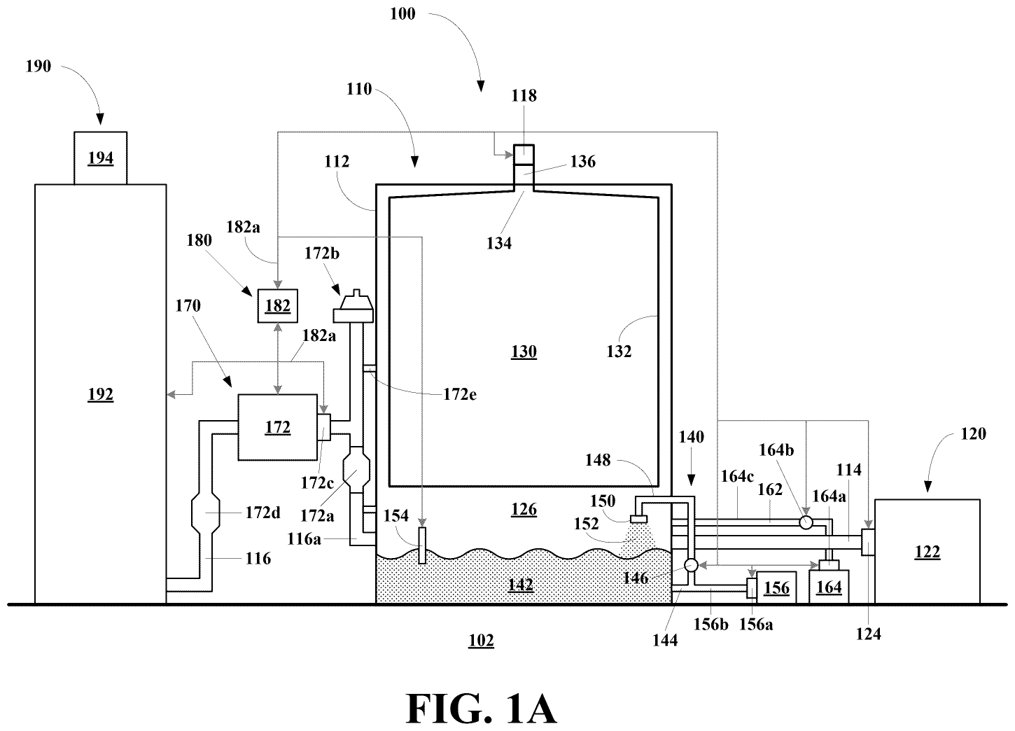

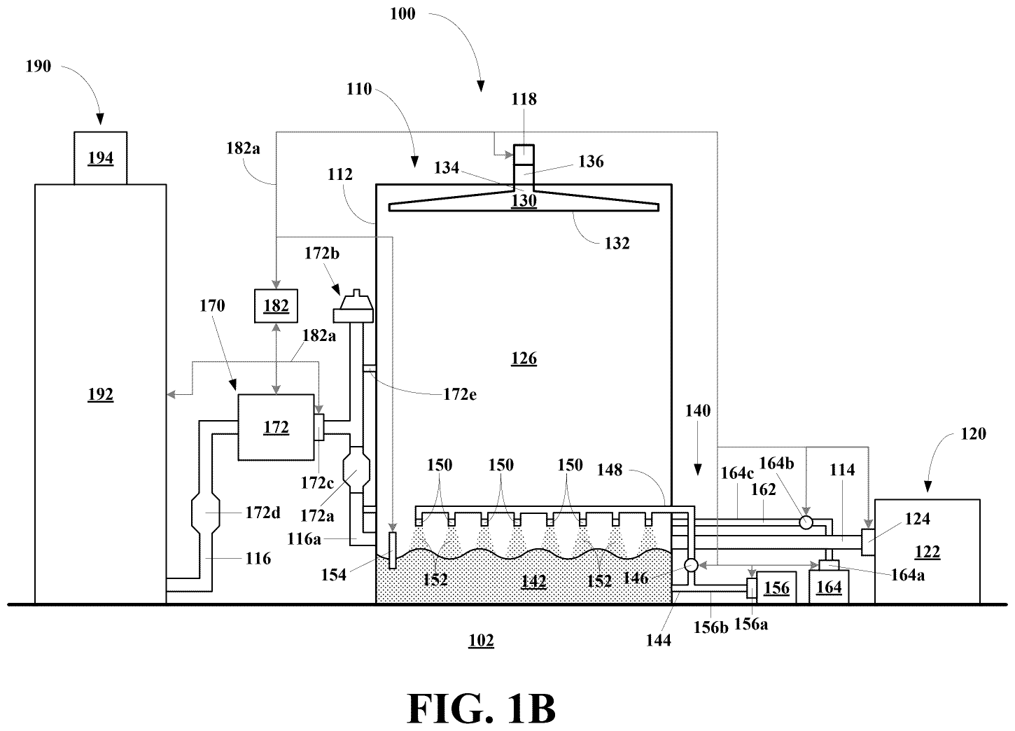

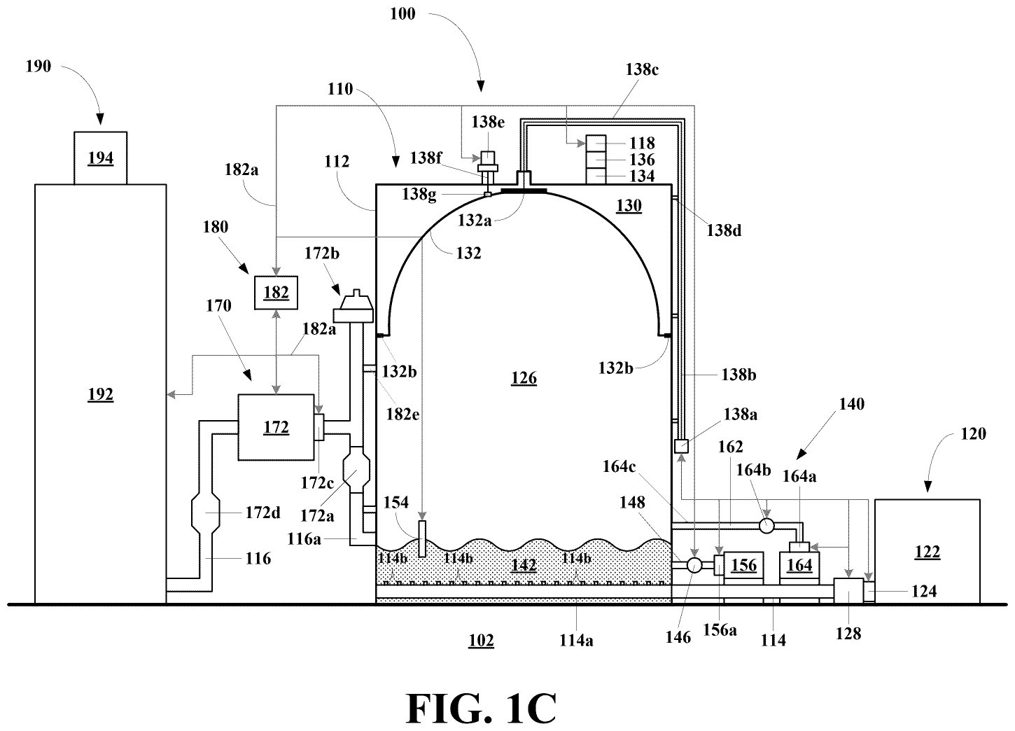

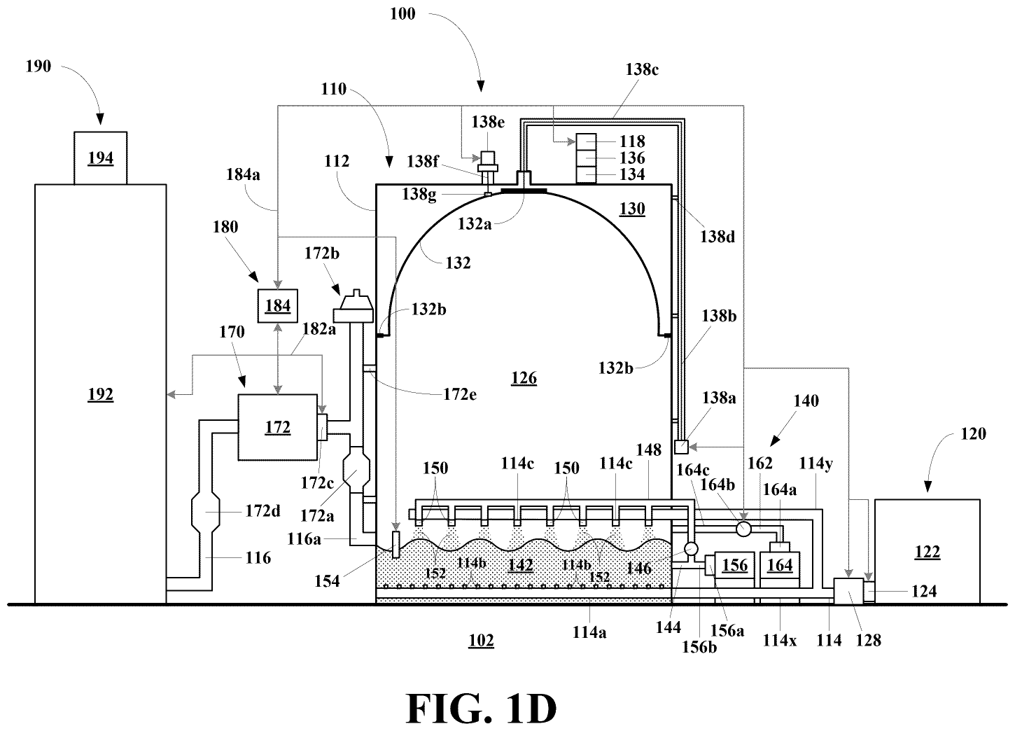

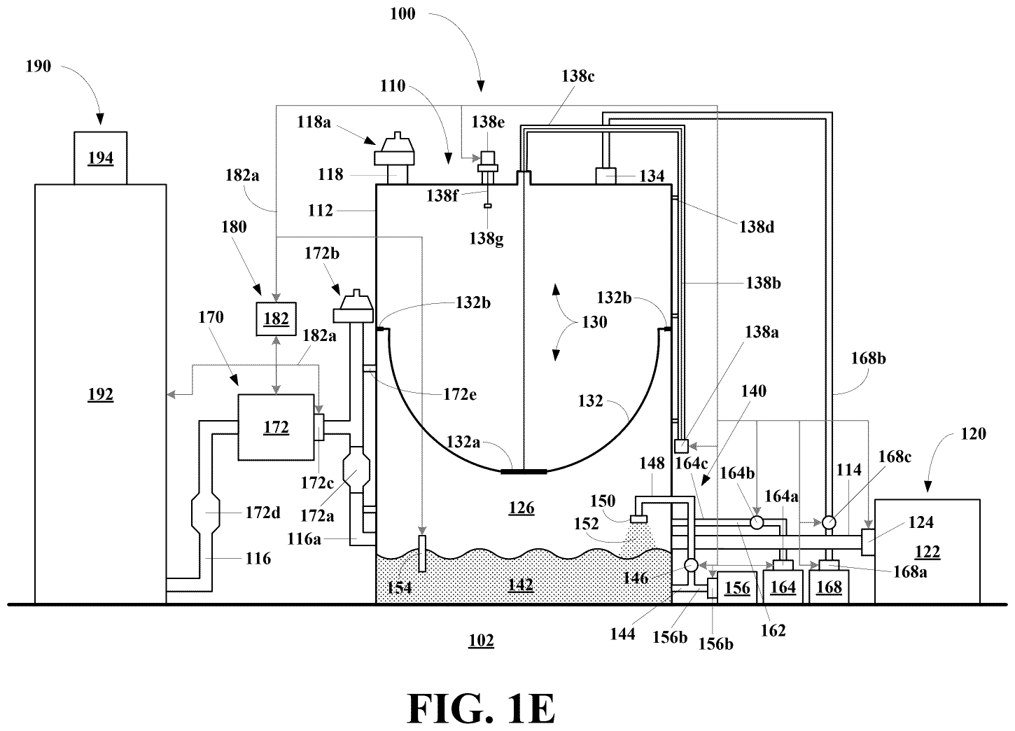

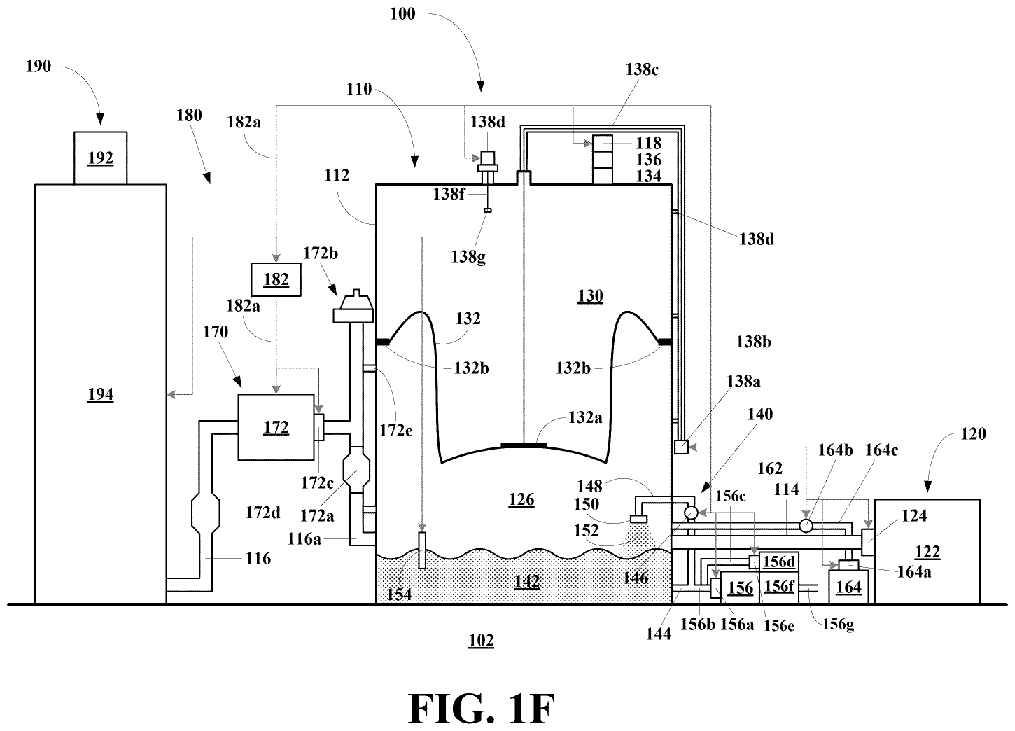

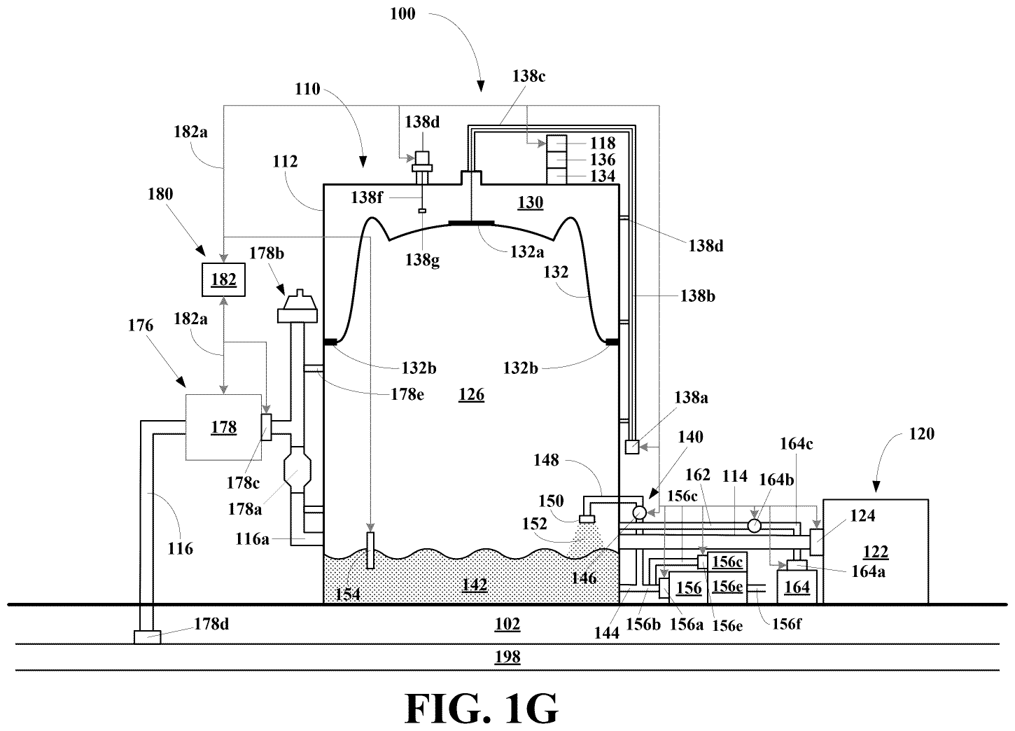

Referring now to FIG. 1A, an embodiment of a vapor storage and treating apparatus or system, generally 100, is shown located on a ground 102. The vapor storage and treating apparatus or system 100 includes a vapor storage assembly or subsystem 110, a vapor supply assembly or subsystem 120, an integrated vapor concentration adjustment assembly or subsystem including an adjustable membrane assembly or subsystem 130, a vapor treating assembly or subsystem 140, a blower and sensor assembly or subsystem 170, an integrated vapor treating control assembly or subsystem 180, and an abatement or incineration assembly or subsystem 190.

The vapor storage assembly or subsystem 110 includes a vapor storage tank 112 having a vapor inlet conduit 114, a vapor outlet conduit 116, and a vapor emission detector device 118. The vapor supply assembly or subsystem 120 includes a vapor source 122 and a vapor source control valve 124 that controls an amount of a vapor 126 being supplied from the vapor source 122 to the vapor storage tank 112.

The adjustable membrane assembly or subsystem 130 includes a balloon or pillow tank type bladder 132 installed in an interior of the vapor storage tank 112. The bladder 132 includes an air or gas conduit 134 and an air or gas vent 136 for air or gas to enter and exit the bladder 132 based on a volume of the vapor 126 in the vapor storage tank 112.

The vapor treating assembly or subsystem 140 includes a liquid 142 disposed in a lower portion or section or heel of the vapor storage tank 112. The liquid 142 is withdrawn from the heel of the vapor storage tank 112 via a liquid recycle conduit 144. The liquid 142 recycled through the liquid recycle conduit 144 is pumped via a liquid pump 146 via a liquid inlet conduit 148 including a liquid sprayer device 150, which produces a stream of liquid droplets 152. The liquid droplet stream 152 is adapted to mix with or absorb a portion of the vapor 126 entering the vapor storage tank 112 via the vapor inlet conduit 114. The vapor treating assembly or subsystem 140 also includes a liquid level sensor device 154. The vapor treating assembly or subsystem 140 also includes a liquid source 156 having a liquid control valve 156a for supplying the liquid 142 to make up for liquid losses or at start up to fill the heel of the vapor storage tank 112 with the liquid 142 via a filling conduit 156b.

The vapor treating assembly or subsystem 140 also includes an adjustment gas 162 from an adjustment gas source 164 having an adjustment gas control valve 164a, an adjustment gas pump 164b, and an adjustment gas conduit 164c for suppling the adjustment gas 162 to the vapor storage tank 112 to assist in adjusting a composition of the vapor 126 in the vapor storage tank 112. The vapor treating assembly or subsystem 140 is designed to adjust the composition of the vapor 126 to a controlled composition using the liquid 126 and the adjustment gas 162. This controlled composition may be a BTU optimized vapor composition, a cleaned vapor composition, a BTU controlled vapor composition, or any other desired vapor composition.

The blower and sensor assembly or subsystem 170 includes a blower 172, a first flame arrestor 172a, an emergency venting device 172b associated with an intermediate vapor output conduit 116a, a vapor composition or BTU sensor 172c, and a second flame arrestor 172d associated with the vapor output conduit 116. The blower 172 is designed to create a steady-state controlled vapor output or vapor volume output stream.

The integrated vapor treating control assembly or subsystem 180 and a control and sensor assembly or subsystem 182. The control and sensor assembly or subsystem 182 includes bidirectional communication pathway 182a. The control and sensor assembly or subsystem 182 also includes one or more processing unit, memory, one or more mass storage devices, one or more input devices, one or more output devices, an operating system, routines for controlling the controllable devices of the apparatuses or system 100, and one or more sensor, e.g., temperature sensors, pressure sensors, liquid and vapor level sensors, any other sensor, or any combination thereof.

The abatement or incineration assembly or subsystem 190 includes an incinerator 192 and an incinerator exhaust port or vent 194. The abatement or incineration assembly or subsystem 190 may include a generator for producing electricity, a steam generator for producing steam, or other equipment designed to utilize the heat of incineration.

Referring now to FIG. 1B, another embodiment of a vapor storage and treating apparatus or system, generally 100, is shown located on a ground 102. The vapor storage and treating apparatus or system 100 includes a vapor storage assembly or subsystem 110, a vapor supply assembly or subsystem 120, an integrated vapor concentration adjustment assembly or subsystem including an adjustable membrane assembly or subsystem 130, a vapor treating assembly or subsystem 140, a blower and sensor assembly or subsystem 170, an integrated vapor treating control assembly or subsystem 180, and an abatement or incineration assembly or subsystem 190.

The vapor storage assembly or subsystem 110 includes a vapor storage tank 112 having a vapor inlet conduit 114, a vapor outlet conduit 116, and a vapor emission detector device 118. The vapor supply assembly or subsystem 120 includes a vapor source 122 and a vapor source control valve 124 that controls an amount of a vapor 126 being supplied from the vapor source 122 to the vapor storage tank 112.

The adjustable membrane assembly or subsystem 130 includes a balloon type bladder 132 installed in an interior of the vapor storage tank 112. The bladder 132 includes an air or gas conduit 134 and an air or gas vent 136 for air or gas to enter and exit the bladder 132 based on a volume of the vapor 126 in the vapor storage tank 112.

The vapor treating assembly or subsystem 140 includes a liquid 142 disposed in a lower portion or section or heel of the vapor storage tank 112. The liquid 142 is withdrawn from the heel of the vapor storage tank 112 via a liquid recycle conduit 144. The liquid 142 recycled through the liquid recycle conduit 144 is pumped via a liquid pump 146 via a liquid inlet conduit 148 including a plurality of liquid sprayer devices 150, which produces an equal plurality of streams of liquid droplets or atomized particles 152. The liquid droplet or atomized particles streams 152 are adapted to mix with or absorb a portion of the vapor 126 entering the vapor storage tank 112 via the vapor inlet conduit 114. The vapor treating assembly or subsystem 140 also includes a liquid level sensor device 154. The vapor treating assembly or subsystem 140 also includes a liquid source 156 having a liquid control valve 156a for supplying the liquid 142 to make up for liquid losses or at start up to fill the heel of the vapor storage tank 112 with the liquid 142 via a filling conduit 156b.

The vapor treating assembly or subsystem 140 also includes an adjustment gas 162 from an adjustment gas source 164 having an adjustment gas control valve 164a, an adjustment gas pump 164b, and an adjustment gas conduit 164c for suppling the adjustment gas 162 to the vapor storage tank 112 to assist in adjusting a composition of the vapor 126 in the vapor storage tank 112. The vapor treating assembly or subsystem 140 is designed to adjust the composition of the vapor 126 to a controlled composition using the liquid 142 and the adjustment gas 162. This controlled composition may be a BTU optimized vapor composition, a cleaned vapor composition, a BTU controlled vapor composition, or any other desired vapor composition.

The blower and sensor assembly or subsystem 170 includes a blower 172, a first flame arrestor 172a, an emergency venting device 172b associated with an intermediate vapor output conduit 116a, a vapor composition or BTU sensor 172c, and a second flame arrestor 172d associated with the vapor output conduit 116. The blower 172 is designed to create a steady-state controlled vapor output or vapor output stream.

The integrated vapor treating control assembly or subsystem 180 and a control and sensor assembly or subsystem 182. The control and sensor assembly or subsystem 182 includes bidirectional communication pathway 182a. The control and sensor assembly or subsystem 182 also includes one or more processing unit, memory, one or more mass storage devices, one or more input devices, one or more output devices, an operating system, routines for controlling the controllable devices of the apparatuses or system 100, and one or more sensor, e.g., temperature sensors, pressure sensors, any other sensor, liquid and vapor level sensors, or any combination thereof.

The abatement or incineration assembly or subsystem 190 includes an incinerator 192 and an incinerator exhaust port or vent 194. The abatement or incineration assembly or subsystem 190 may include a generator for producing electricity, a steam generator for producing steam, or other equipment designed to utilize the heat of incineration.

### Vapor Treating and Incineration Embodiments Using a Hemispherical Ring Type Bladder

Referring now to FIG. 1C, another embodiment of a vapor storage and treating apparatus or system, generally 100, is shown located on a ground 102. The vapor storage and treating apparatus or system 100 includes a vapor storage assembly or subsystem 110, a vapor supply assembly or subsystem 120, an integrated vapor concentration adjustment assembly or subsystem including an adjustable membrane assembly or subsystem 130, a vapor treating assembly or subsystem 140, a blower and sensor assembly or subsystem 170, an integrated vapor treating control assembly or subsystem 180, and an abatement or incineration assembly or subsystem 190.

The vapor storage assembly or subsystem 110 includes a vapor storage tank 112 having a vapor inlet conduit 114, and a tank inlet conduit 114a having vapor outlet orifices 114b for a vapor outlet conduit 116, and a vapor emission detector device 118. The vapor supply assembly or subsystem 120 includes a vapor source 122, a vapor source control valve 124 that controls an amount of a vapor 126 being supplied from the vapor source 122 to the vapor storage tank 112 and a vapor blower 128 for increasing a pressure of the vapor supplied to the tank inlet conduit 114a to introduce the vapor 126 through the orifices 114b into the liquid 142.

The adjustable membrane assembly or subsystem 130 includes a hemispherical ring type bladder 132 including a central weight 132a installed in an interior of the vapor storage tank 112 and anchored to a central location in the vapor storage tank 112 via a ring 132b. The adjustable membrane assembly or subsystem 130 also includes an air or gas vent conduit 134, and an air or gas vent 136 for air or gas to enter and exit the bladder 132 based on a volume of the vapor 126 in the vapor storage tank 112. The adjustable membrane assembly or subsystem 130 also include a tape type vapor level sensor 138a including a tape 138b, a tape type vapor level sensor conduit 138c anchored to the vapor tank 112 via mounts 138d and a Hi-Hi vapor level sensor 138e including a hanging member 138f and a member attachment 138g.

The vapor treating assembly or subsystem 140 includes the liquid 142 disposed in a lower portion or section or heel of the vapor storage tank 112. The liquid 142 is supplied to the heel of the vapor storage tank 112 via a liquid inlet conduit 148. The vapor treating assembly or subsystem 140 also includes a liquid level sensor device 154. The vapor treating assembly or subsystem 140 also includes a liquid source 156 having a liquid control valve 156a for supplying the liquid 142 to make up for liquid losses or at start up to fill the heel of the vapor storage tank 112 with the liquid 142 via the liquid inlet conduit 148.

The vapor treating assembly or subsystem 140 also includes an adjustment gas 162 from an adjustment gas source 164 having an adjustment gas control valve 164a, an adjustment gas pump 164b, and an adjustment gas conduit 164c for suppling the adjustment gas 162 to the vapor storage tank 112 to assist in adjusting a composition of the vapor 126 in the vapor storage tank 112. The vapor treating assembly or subsystem 140 is designed to adjust the composition of the vapor 126 to a controlled composition using the liquid 126 and the adjustment gas 162. This controlled composition may be a BTU optimized vapor composition, a cleaned vapor composition, a BTU controlled vapor composition, or any other desired vapor composition.

The blower and sensor assembly or subsystem 170 includes a blower 172, a first flame arrestor 172a, an emergency venting device 172b associated with an intermediate vapor output conduit 116a, a vapor composition or BTU sensor 172c, and a second flame arrestor 172d associated with the vapor output conduit 116. The blower 172 is designed to create a steady-state controlled vapor output or vapor volume output stream.

The integrated vapor treating control assembly or subsystem 180 and a control and sensor assembly or subsystem 182. The control and sensor assembly or subsystem 182 includes bidirectional communication pathway 182a. The control and sensor assembly or subsystem 182 also includes one or more processing unit, memory, one or more mass storage devices, one or more input devices, one or more output devices, an operating system, routines for controlling the controllable devices of the apparatuses or system 100, and one or more sensor, e.g., temperature sensors, pressure sensors, any other sensor, liquid and vapor level sensors, or any combination thereof.

The abatement or incineration assembly or subsystem 190 includes an incinerator 192 and an incinerator exhaust port or vent 194. The abatement or incineration assembly or subsystem 190 may include a generator for producing electricity, a steam generator for producing steam, or other equipment designed to utilize the heat of incineration.

Referring now to FIG. 1D, another embodiment of a vapor storage and treating apparatus or system, generally 100, is shown located on a ground 102. The vapor storage and treating apparatus or system 100 includes a vapor storage assembly or subsystem 110, a vapor supply assembly or subsystem 120, an integrated vapor concentration adjustment assembly or subsystem including an adjustable membrane assembly or subsystem 130, a vapor treating assembly or subsystem 140, a blower and sensor assembly or subsystem 170, an integrated vapor treating control assembly or subsystem 180, and an abatement or incineration assembly or subsystem 190.

The vapor storage assembly or subsystem 110 includes a vapor storage tank 112 having a vapor inlet conduit 114, a first vapor outlet conduit 114x, a second vapor outlet conduit 114y, and a tank inlet conduit 114a having vapor outlet orifices 114b for a vapor outlet conduit 116, and a vapor emission detector device 118. The vapor supply assembly or subsystem 120 includes a vapor source 122, a vapor source control valve 124 that controls an amount of a vapor 126 being supplied from the vapor source 122 to the vapor storage tank 112 and a vapor blower 128 for increasing a pressure of the vapor supplied to the tank inlet conduit 114a to introduce the vapor 126 through the orifices 114b into a liquid 142.

The adjustable membrane assembly or subsystem 130 includes a hemispherical ring type bladder 132 including a central weight 132a installed in an interior of the vapor storage tank 112 and anchored to a central location in the vapor storage tank 112 via a ring 132b. The adjustable membrane assembly or subsystem 130 also includes an air or gas vent conduit 134 and an air or an air or gas vent 136 for air or gas to enter and exit the bladder 132 based on a volume of the vapor 126 in the vapor storage tank 112. The adjustable membrane assembly or subsystem 130 also include a tape type vapor level sensor 138a including a tape 138b, a tape type vapor level sensor conduit 138c anchored to the vapor tank 112 via mounts 138d and a Hi-Hi vapor level sensor 138e including a hanging member 138f and a member attachment 138g.

The vapor treating assembly or subsystem 140 includes the liquid 142 disposed in a lower portion or section or heel of the vapor storage tank 112. The liquid 142 is withdrawn from the heel of the vapor storage tank 112 via a liquid recycle conduit 144. The liquid 142 recycled through the liquid recycle conduit 144 is pumped via a liquid pump 146 via a liquid inlet conduit 148 including a plurality of liquid sprayer devices 150, which produces a plurality of streams of liquid droplets or atomized particles 152. The liquid droplet or atomized particle streams 152 are adapted to mix with or absorb a portion of the vapor 126 entering the vapor storage tank 112 via the vapor inlet conduit 114y and exiting through orifices 114c formed in the vapor inlet conduit 114y so that the vapor 126 enters into the droplet streams 152 individually. The vapor treating assembly or subsystem 140 also includes a liquid level sensor device 154. The vapor treating assembly or subsystem 140 also includes a liquid source 156 having a liquid control valve 156a for supplying the liquid 142 to make up for liquid losses or at start up to fill the heel of the vapor storage tank 112 with the liquid 142 via a filling conduit 156b.

The vapor treating assembly or subsystem 140 also includes an adjustment gas 162 from an adjustment gas source 164 having an adjustment gas control valve 164a, an adjustment gas pump 164b, and an adjustment gas conduit 164c for suppling the adjustment gas 162 to the vapor storage tank 112 to assist in adjusting a composition of the vapor 126 in the vapor storage tank 112. The vapor treating assembly or subsystem 140 is designed to adjust the composition of the vapor 126 to a controlled composition using the liquid 142 and the adjustment gas 162. This controlled composition may be a BTU optimized vapor composition, a cleaned vapor composition, a BTU controlled vapor composition, or any other desired vapor composition.

The blower and sensor assembly or subsystem 170 includes a blower 172, a first flame arrestor 172a, an emergency venting device 172b associated with an intermediate vapor output conduit 116a, a vapor composition or BTU sensor 172c, and a second flame arrestor 172d associated with the vapor output conduit 116. The blower 172 is designed to create a steady-state controlled vapor output or vapor volume output stream.

The integrated vapor treating control assembly or subsystem 180 and a control and sensor assembly or subsystem 182. The control and sensor assembly or subsystem 182 includes bidirectional communication pathway 182a. The control and sensor assembly or subsystem 182 also includes one or more processing unit, memory, one or more mass storage devices, one or more input devices, one or more output devices, an operating system, routines for controlling the controllable devices of the apparatuses or system 100, and one or more sensor, e.g., temperature sensors, pressure sensors, any other sensor, liquid and vapor level sensors, or any combination thereof.

The abatement or incineration assembly or subsystem 190 includes an incinerator 192 and an incinerator exhaust port or vent 194. The abatement or incineration assembly or subsystem 190 may include a generator for producing electricity, a steam generator for producing steam, or other equipment designed to utilize the heat of incineration.

Referring now to FIG. 1E, another embodiment of a vapor storage and treating apparatus or system, generally 100, is shown located on a ground 102. The vapor storage and treating apparatus or system 100 includes a vapor storage assembly or subsystem 110, a vapor supply assembly or subsystem 120, an integrated vapor concentration adjustment assembly or subsystem including an adjustable membrane assembly or subsystem 130, a vapor treating assembly or subsystem 140, a blower and sensor assembly or subsystem 170, an integrated vapor treating control assembly or subsystem 180, and an abatement or incineration assembly or subsystem 190.

The vapor storage assembly or subsystem 110 includes a vapor storage tank 112 having a vapor inlet conduit 114, a vapor outlet conduit 116, and a vapor emission detector device 118. The vapor supply assembly or subsystem 120 includes a vapor source 122 and a vapor source control valve 124 that controls an amount of a vapor 126 being supplied from the vapor source 122 to the vapor storage tank 112.

The adjustable membrane assembly or subsystem 130 includes a hemispherical ring type bladder 132 including a central weight 132a installed in an interior of the vapor storage tank 112 and anchored to a central location in the vapor storage tank 112 via a ring 132b. The adjustable membrane assembly or subsystem 130 also an air or gas vent conduit 134 and an air or gas vent 136 for air or gas to enter and exit the bladder 132 based on a volume of the vapor 126 in the vapor storage tank 112. The adjustable membrane assembly or subsystem 130 also include a tape type vapor level sensor 138a including a tape 138b, a tape type vapor level sensor conduit 138c anchored to the vapor tank 112 via mounts 138d and a Hi-Hi vapor level sensor 138e including a hanging member 138f and a member attachment 138g.

The vapor treating assembly or subsystem 140 includes a liquid 142 disposed in a lower portion or section or heel of the vapor storage tank 112. The liquid 142 is withdrawn from the heel of the vapor storage tank 112 via a liquid recycle conduit 144. The liquid 142 recycled through the liquid recycle conduit 144 is pumped via a liquid pump 146 via a liquid inlet conduit 148 including a liquid sprayer device 150, which produces a stream of liquid droplets or atomized particles 152. The liquid droplet or atomized particle stream 152 is adapted to mix with or absorb a portion of the vapor 126 entering the vapor storage tank 112 via the vapor inlet conduit 114. The vapor treating assembly or subsystem 140 also includes a liquid level sensor device 154. The vapor treating assembly or subsystem 140 also includes a liquid source 156 having a liquid control valve 156a for supplying the liquid 142 to make up for liquid losses or at start up to fill the heel of the vapor storage tank 112 with the liquid 142 via a filling conduit 156b.

The vapor treating assembly or subsystem 140 also includes an adjustment gas 162 from an adjustment gas source 164 having an adjustment gas control valve 164a, an adjustment gas pump 164b, and an adjustment gas conduit 164c for suppling the adjustment gas 162 to the vapor storage tank 112 to assist in adjusting a composition of the vapor 126 in the vapor storage tank 112. The vapor treating assembly or subsystem 140 is designed to adjust the composition of the vapor 126 to a controlled composition using the liquid 142 and the adjustment gas 162. This controlled composition may be a BTU optimized vapor composition, a cleaned vapor composition, a BTU controlled vapor composition, or any other desired vapor composition.

The vapor treating assembly or subsystem 140 also includes a gas supply source 168 for supply a gas 168a supplied to the vapor tank 112 and into the bladder system 130 and including a gas control valve 168b, an air or gas conduit 168c and a gas pump 168d. The gas 168a may be air or a non-flammable gas and the pump 168d may be used to increase a gas pressure within the membrane assembly or subsystem 130 and thereby increasing a pressure of the vapor 126 in the vapor storage tank 112.

The blower and sensor assembly or subsystem 170 includes a blower 172, a first flame arrestor 172a, an emergency venting device 172b associated with an intermediate vapor output conduit 116a, a vapor composition or BTU sensor 172c, and a second flame arrestor 172d associated with the vapor output conduit 116. The blower 172 is designed to create a steady-state controlled vapor output or vapor volume output stream.

The integrated vapor treating control assembly or subsystem 180 and a control and sensor assembly or subsystem 182. The control and sensor assembly or subsystem 182 includes bidirectional communication pathway 182a. The control and sensor assembly or subsystem 182 also includes one or more processing unit, memory, one or more mass storage devices, one or more input devices, one or more output devices, an operating system, routines for controlling the controllable devices of the apparatuses or system 100, and one or more sensor, e.g., temperature sensors, pressure sensors, liquid and vapor level sensors, any other sensor, or any combination thereof.

The abatement or incineration assembly or subsystem 190 includes an incinerator 192 and an incinerator exhaust port or vent 194. The abatement or incineration assembly or subsystem 190 may include a generator for producing electricity, a steam generator for producing steam, or other equipment designed to utilize the heat of incineration.

### Vapor Treating and Incineration Embodiments Using a Conical Ring Type Bladder

Referring now to FIG. 1F, another embodiment of a vapor storage and treating apparatus or system, generally 100, is shown located on a ground 102. The vapor storage and treating apparatus or system 100 includes a vapor storage assembly or subsystem 110, a vapor supply assembly or subsystem 120, an integrated vapor concentration adjustment assembly or subsystem including an adjustable membrane assembly or subsystem 130, a vapor treating assembly or subsystem 140, a blower and sensor assembly or subsystem 170, an integrated vapor treating control assembly or subsystem 180, and an abatement or incineration assembly or subsystem 190.

The vapor storage assembly or subsystem 110 includes a vapor storage tank 112 having a vapor inlet conduit 114, a vapor outlet conduit 116, and a vapor emission detector device 118. The vapor supply assembly or subsystem 120 includes a vapor source 122 and a vapor source control valve 124 that controls an amount of a vapor 126 being supplied from the vapor source 122 to the vapor storage tank 112.

The adjustable membrane assembly or subsystem 130 includes a conical ring type bladder 132 including a central weight 132a installed in an interior of the vapor storage tank 112 and anchored to a central location in the vapor storage tank 112 via a ring 132b. The adjustable membrane assembly or subsystem 130 also an air or gas vent conduit 134 and an air or gas vent 136 for air or gas to enter and exit the bladder 132 based on a volume of the vapor 126 in the vapor storage tank 112. The adjustable membrane assembly or subsystem 130 also include a tape type vapor level sensor 138a including a tape 138b, a tape type vapor level sensor conduit 138c anchored to the vapor tank 112 via mounts 138d and a Hi-Hi vapor level sensor 138e including a hanging member 138f and a member attachment 138g. Here, the bladder 132 is near maximum fill and the vapor volume is near a minimum.

The vapor treating assembly or subsystem 140 includes a liquid 142 disposed in a lower portion or section or heel of the vapor storage tank 112. The liquid 142 is withdrawn from the heel of the vapor storage tank 112 via a liquid recycle conduit 144. The liquid 142 recycled through the liquid recycle conduit 144 is pumped via a liquid pump 146 via a liquid inlet conduit 148 including a liquid sprayer or atomizer device 150, which produces a stream of liquid droplets or atomized particles 152. The liquid droplet or atomized particle stream 152 is adapted to mix with or absorb a portion of the vapor 126 entering the vapor storage tank 112 via the vapor inlet conduit 114. The vapor treating assembly or subsystem 140 also includes a liquid level sensor device 154. The vapor treating assembly or subsystem 140 also includes a liquid source 156 having a liquid control valve 156a for supplying the liquid 142 to make up for liquid losses or at start up to fill the heel of the vapor storage tank 112 with the liquid 142 via a filling conduit 156b.

If the vapor 126 is contains contaminates such as hydrogen sulfide, hydrocyanide, any other contaminate, or any mixture thereof, the vapor treating assembly or subsystem 140 also includes a scavenging agent source 156d and a scavenging agent control valve 156e for introducing scavenging agents into the liquid 142. The vapor treating assembly or subsystem 140 also includes a purification unit 156f having a waste stream outlet 156g for removing scavenged contaminates from the liquid 142. The waste stream outlet 156g may be forwarded to a waste processing facility or barreled in barrels for disposal at a disposal facility.

The vapor treating assembly or subsystem 140 also includes an adjustment gas 162 from an adjustment gas source 164 having an adjustment gas control valve 164a, an adjustment gas pump 164b, and an adjustment gas conduit 164c for suppling the adjustment gas 162 to the vapor storage tank 112 to assist in adjusting a composition of the vapor 126 in the vapor storage tank 112. The vapor treating assembly or subsystem 140 is designed to adjust the composition of the vapor 126 to a controlled composition using the liquid 142 and the adjustment gas 162. This controlled composition may be a BTU optimized vapor composition, a cleaned vapor composition, a BTU controlled vapor composition, or any other desired vapor composition.

The blower and sensor assembly or subsystem 170 includes a blower 172, a first flame arrestor 172a, an emergency venting device 172b associated with an intermediate vapor output conduit 116a, a vapor composition or BTU sensor 172c, and a second flame arrestor 172d associated with the vapor output conduit 116. The blower 172 is designed to create a steady-state controlled vapor output or vapor output stream.

The integrated vapor treating control assembly or subsystem 180 and a control and sensor assembly or subsystem 182. The control and sensor assembly or subsystem 182 includes bidirectional communication pathway 182a. The control and sensor assembly or subsystem 182 also includes one or more processing unit, memory, one or more mass storage devices, one or more input devices, one or more output devices, an operating system, routines for controlling the controllable devices of the apparatuses or system 100, and one or more sensor, e.g., temperature sensors, pressure sensors, any other sensor, liquid and vapor level sensors, or any combination thereof.

The abatement or incineration assembly or subsystem 190 includes an incinerator 192 and an incinerator exhaust port or vent 194. The abatement or incineration assembly or subsystem 190 may include a generator for producing electricity, a steam generator for producing steam, or other equipment designed to utilize the heat of incineration.

Referring now to FIG. 1G, another embodiment of a vapor storage and treating apparatus or system, generally 100, is shown located on a ground 102. The vapor storage and treating apparatus or system 100 includes a vapor storage assembly or subsystem 110, a vapor supply assembly or subsystem 120, an integrated vapor concentration adjustment assembly or subsystem including an adjustable membrane assembly or subsystem 130, a vapor treating assembly or subsystem 140, a pipeline introduction and sensor assembly 176, and an integrated vapor treating control assembly or subsystem 180.

The vapor storage assembly or subsystem 110 includes a vapor storage tank 112 having a vapor inlet conduit 114, a vapor outlet conduit 116, and a vapor emission detector device 118. The vapor supply assembly or subsystem 120 includes a vapor source 122 and a vapor source control valve 124 that controls an amount of a vapor 126 being supplied from the vapor source 122 to the vapor storage tank 112.

The adjustable membrane assembly or subsystem 130 includes a conical ring type bladder 132 including a central weight 132a installed in an interior of the vapor storage tank 112 and anchored to a central location in the vapor storage tank 112 via a ring 132b. The adjustable membrane assembly or subsystem 130 also an air or gas vent conduit 134 and an air or gas vent 136 for air or gas to enter and exit the bladder 132 based on a volume of the vapor 126 in the vapor storage tank 112. The adjustable membrane assembly or subsystem 130 also include a tape type vapor level sensor 138a including a tape 138b, a tape type vapor level sensor conduit 138c anchored to the vapor tank 112 via mounts 138d and a Hi-Hi vapor level sensor 138e including a hanging member 138f and a member attachment 138g. Here, the bladder 132 is near minimum fill and the vapor volume is near a maximum.

The vapor treating assembly or subsystem 140 includes a liquid 142 disposed in a lower portion or section or heel of the vapor storage tank 112. The liquid 142 is withdrawn from the heel of the vapor storage tank 112 via a liquid recycle conduit 144. The liquid 142 recycled through the liquid recycle conduit 144 is pumped via a liquid pump 146 via a liquid inlet conduit 148 including a liquid sprayer device 150, which produces a stream of liquid droplets or atomized particles 152. The liquid droplet or atomized particle stream 152 is adapted to mix with or absorb a portion of the vapor 126 entering the vapor storage tank 112 via the vapor inlet conduit 114. The vapor treating assembly or subsystem 140 also includes a liquid level sensor device 154. The vapor treating assembly or subsystem 140 also includes a liquid source 156 having a liquid control valve 156a for supplying the liquid 142 to make up for liquid losses or at start up to fill the heel of the vapor storage tank 112 with the liquid 142 via a filling conduit 156b.

If the vapor 126 is contains contaminates such as hydrogen sulfide, hydrocyanide, any other contaminate, or any mixture thereof, the vapor treating assembly or subsystem 140 also includes a scavenging agent source 156d and a scavenging agent control valve 156e for introducing scavenging agents into the liquid 142. The vapor treating assembly or subsystem 140 also includes a purification unit 156f having an outlet 156g for removing scavenged contaminates from the liquid 142.

The vapor treating assembly or subsystem 140 also includes an adjustment gas 162 from an adjustment gas source 164 having an adjustment gas control valve 164a, an adjustment gas pump 164b, and an adjustment gas conduit 164c for suppling the adjustment gas 162 to the vapor storage tank 112 to assist in adjusting a composition of the vapor 126 in the vapor storage tank 112. The vapor treating assembly or subsystem 140 is designed to adjust the composition of the vapor 126 to a controlled composition using the liquid 142 and the adjustment gas 162. This controlled composition may be a BTU optimized vapor composition, a cleaned vapor composition, a BTU controlled vapor composition, or any other desired vapor composition.

The pipeline introduction and sensor assembly 176 includes a gas compression unit 178, a first flame arrestor 178a, an emergency venting device 178b associated with an intermediate vapor output conduit 116a, a vapor composition or BTU sensor 178c, and a pipeline introduction valve 178d associated with the vapor output conduit 116. The gas compression unit 178 is designed to create a steady-state controlled vapor output or vapor output stream at the pipeline pressure and composition.

The integrated vapor treating control assembly or subsystem 180 and a control and sensor assembly or subsystem 182. The control and sensor assembly or subsystem 182 includes bidirectional communication pathway 182a. The control and sensor assembly or subsystem 182 also includes one or more processing unit, memory, one or more mass storage devices, one or more input devices, one or more output devices, an operating system, routines for controlling the controllable devices of the apparatuses or system 100, and one or more sensor, e.g., temperature sensors, pressure sensors, any other sensor, liquid and vapor level sensors, or any combination thereof.

The integrated vapor treating control assembly or subsystem 180 of FIGS. 1A-G are configured to receive data from the various sensors associated with the apparatuses or systems 100, especially the vapor composition sensors, the BTU sensors, the liquid level sensors, the vapor level sensors, the temperature sensors, the pressure sensors, and the abatement device and to send instructions to the flow control valves, the blower assembly, and the pumps or the compressors assembly. The instructions send by the integrated vapor treating control assembly or subsystem 180 are configured to control an effluent or output composition of the vapor for subsequent use such as incineration abatement, pipeline injection, or other abatement uses and to control an effluent or output volumetric flow rate of the effluent or output composition of the vapor, so that the effluent or output volumetric flow rate is steady and controlled both for abatement and pipeline injection. Additionally, for uses that require removal of contaminates from the vapor, the integrated vapor treating control assembly or subsystem 180 are also configured to control the injection of scavengers into the vapor and to control the removal of contaminates from the liquid, especially for pipeline injection or other similar uses.

It should be recognized that the integrated vapor treating control assembly or subsystem 180 of FIGS. 1A-G may be located in an onsite facility or an offsite facility. The onsite facility may be a separate building or housed in a facility associated with the vapor supply facility or the vapor abatement facility or the pipeline operation facility. The offsite facility may be located in a building or operated from any remote location having internet access.

### Integrated Gas Storage and Vapor Treatment Apparatuses or Systems Embodiments

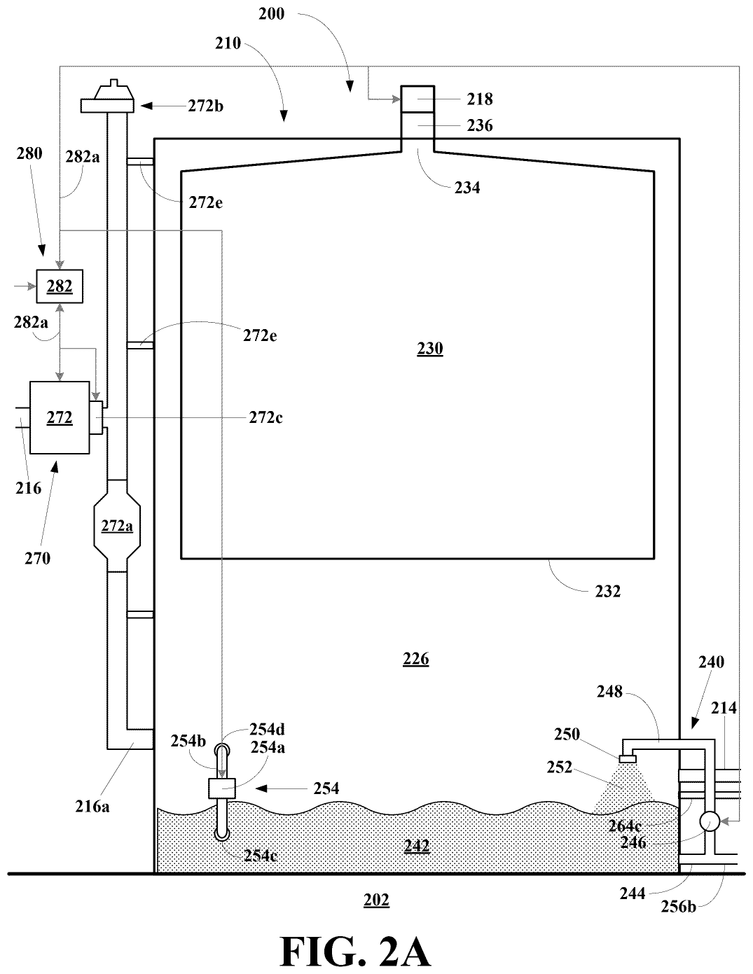

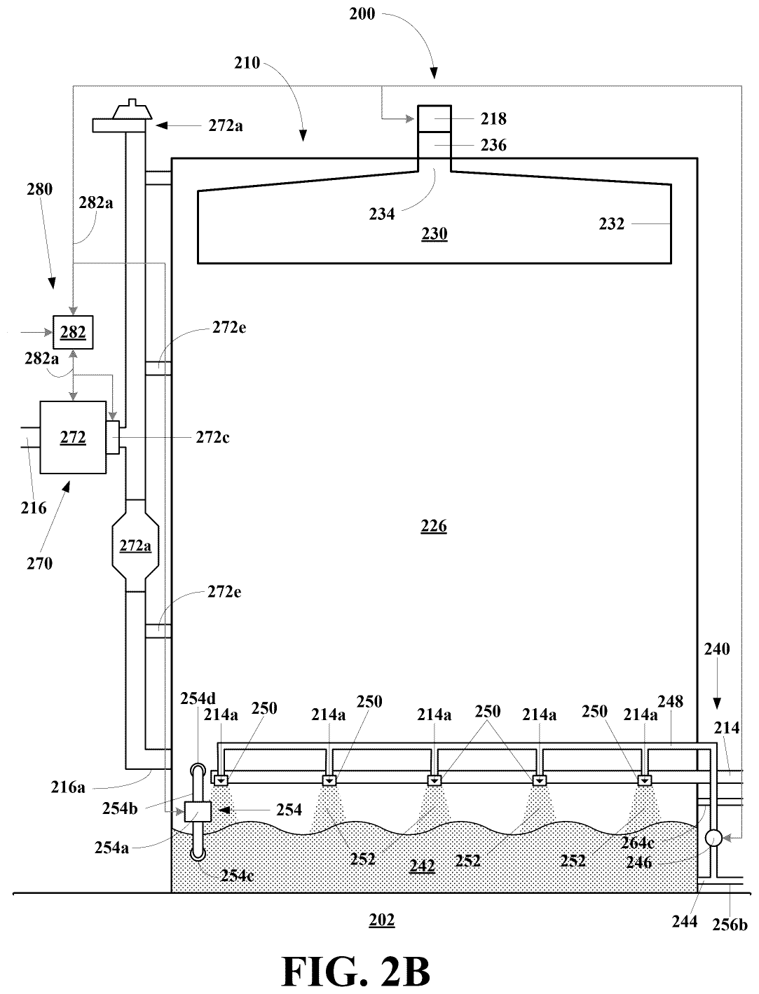

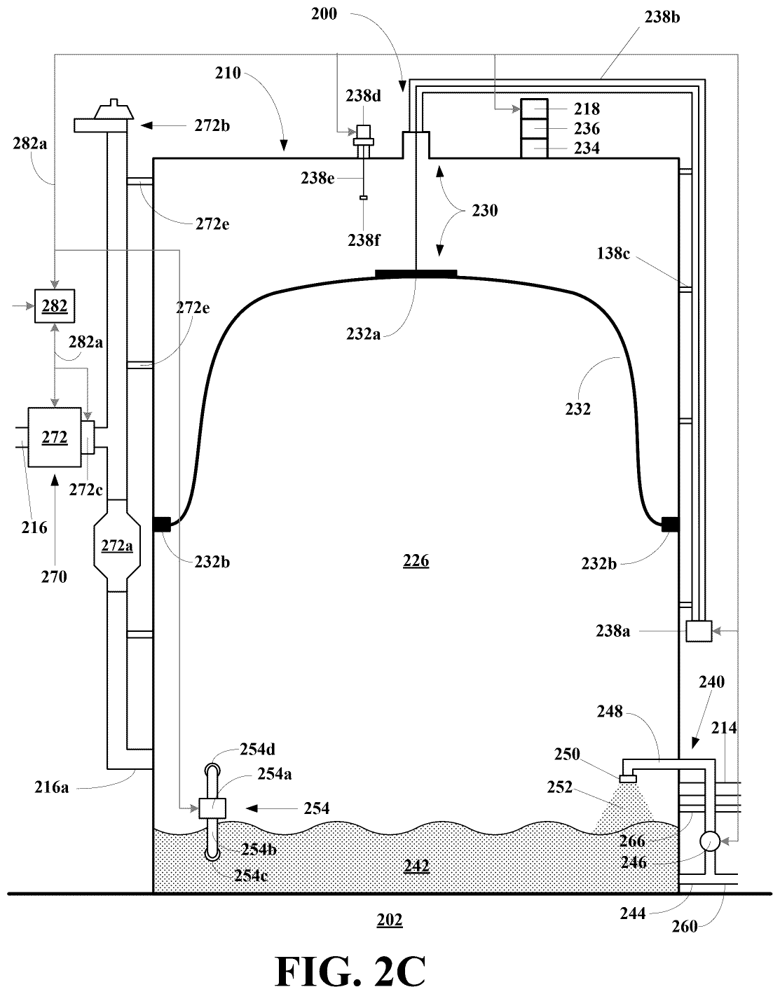

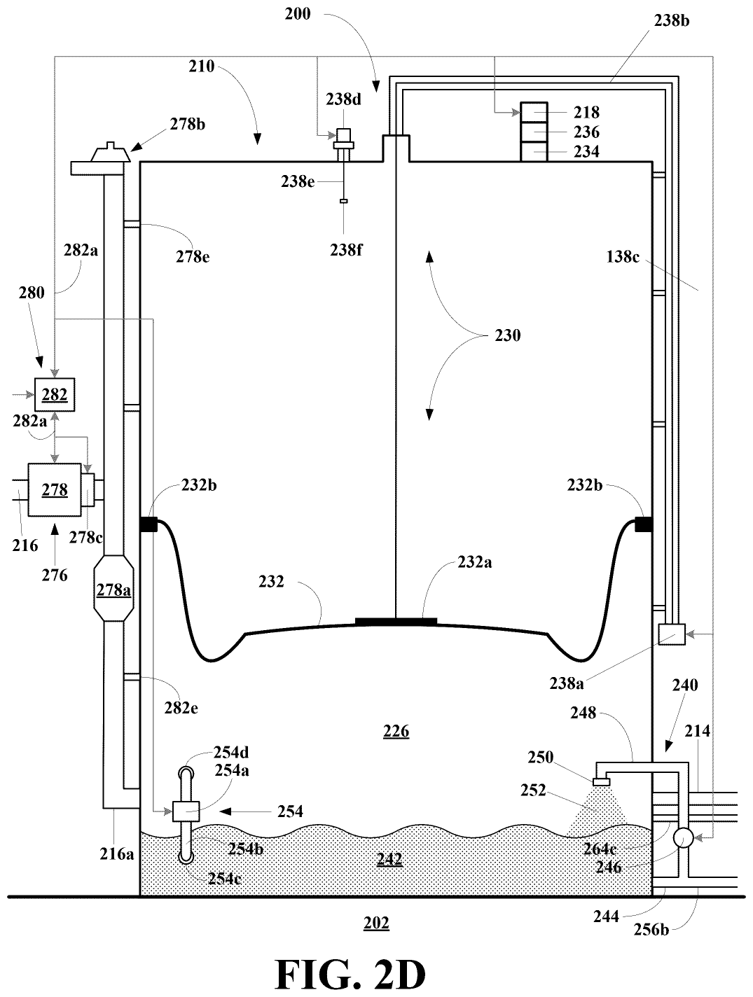

Referring now to FIG. 2A, an embodiment of an integrated vapor concentration adjustment and treatment apparatus or system, generally 200 includes a vapor storage assembly or subsystem 210 located on a ground location 202, a vapor supply assembly or subsystem 220, an integrated vapor concentration adjustment and treatment assembly or subsystem including an adjustable membrane assembly or subsystem 230, a vapor treating assembly or subsystem 240, a blower and sensor assembly or subsystem 270, and an integrated vapor treating control assembly or subsystem 280.

The vapor storage assembly or subsystem 210 includes a vapor storage tank 212 having a vapor inlet conduit 214, a vapor outlet conduit 216, and a vapor emission detector device 218. The vapor supply assembly or subsystem 220 includes a vapor source 222 and a vapor source control valve 224 that controls an amount of a vapor 226 being supplied from the vapor source 222 to the vapor storage tank 212.

The adjustable membrane assembly or subsystem 230 includes a balloon type bladder 232 installed in an interior of the vapor storage tank 212. The bladder 232 includes an air or gas conduit 234 and an air or gas vent 236 for gas or gas to enter and exit the bladder 232 based on a volume of the vapor 226 in the vapor storage tank 212. Here, the bladder 232 is shown more than half inflated meaning that the vapor volume of the vapor 226 in the vapor storage tank 212 is less than half.

The vapor treating assembly or subsystem 240 includes a liquid 242 disposed in a lower portion or section or heel of the vapor storage tank 212. The liquid 242 is withdrawn from the heel of the vapor storage tank 212 via a liquid recycle conduit 244. The liquid 242 recycled through the liquid recycle conduit 244 is pumped via a liquid pump 246 via a liquid inlet conduit 248 including a liquid sprayer device 250, which produces a stream of liquid droplets 252. The liquid droplet stream 252 is adapted to mix with or absorb a portion of the vapor 226 entering the vapor storage tank 212 via the vapor inlet conduit 214. The vapor treating assembly or subsystem 240 also includes a liquid level sensor device 254. The liquid level sensor device 254 includes a level sensor 254a, a sensor liquid conduit 254b, a liquid inlet port 254c, and a liquid outlet port 254d. The liquid inlet port 254c is disposed below a liquid level of the liquid 242 in the heel of the vapor storage tank 212, while the liquid outlet port 254d is disposed above the liquid level of the liquid 242 in the heel of the vapor storage tank 212. Make up or start up liquid is supplied via liquid supply conduit 256b.

The vapor treating assembly or subsystem 240 also includes an adjustment gas 262 supplied to the vapor storage tank 212 via an adjustment gas conduit 264c. The vapor treating assembly or subsystem 240 is designed to adjust the composition of the vapor 226 to a controlled composition using the liquid 226 and the adjustment gas 262 This controlled composition may be a BTU optimized vapor composition, a cleaned vapor composition, a BTU controlled vapor composition, or any other desired vapor composition.

The blower and sensor assembly or subsystem 270 includes a blower 272, a first flame arrestor 272a, an emergency venting device 272b associated with an intermediate vapor output conduit 216a, a vapor composition or BTU sensor 272c, and a second flame arrestor 272d associated with the vapor output conduit 216. The blower 272 is designed to create a steady-state controlled vapor output or vapor output stream.

The integrated vapor treating control assembly or subsystem 280 and a control and sensor assembly or subsystem 282. The control and sensor assembly or subsystem 282 includes bidirectional communication pathway 282a. The control and sensor assembly or subsystem 282 also includes one or more processing unit, memory, one or more mass storage devices, one or more input devices, one or more output devices, an operating system, routines for controlling the controllable devices of the apparatuses or system 200, and one or more sensor, e.g., temperature sensors, pressure sensors, any other sensor, or any combination thereof.

Referring now to FIG. 2B, another embodiment of an integrated vapor concentration adjustment and treatment apparatus or system, generally 200 includes a vapor storage assembly or subsystem 210 located on a ground location 202, a vapor supply assembly or subsystem 220, an integrated vapor concentration adjustment and treatment assembly or subsystem including an adjustable membrane assembly or subsystem 230, a vapor treating assembly or subsystem 240, a blower and sensor assembly or subsystem 270, and an integrated vapor treating control assembly or subsystem 280.

The vapor storage assembly or subsystem 210 includes a vapor storage tank 212 having a vapor inlet conduit 214, a vapor outlet conduit 216, and a vapor emission detector device 218. The vapor supply assembly or subsystem 220 includes a vapor source 222 and a vapor source control valve 224 that controls an amount of a vapor 226 being supplied from the vapor source 222 to the vapor storage tank 212.

The adjustable membrane assembly or subsystem 230 includes a balloon type bladder 232 installed in an interior of the vapor storage tank 212. The bladder 232 includes an air or gas conduit 234 and an air or gas vent 236 for air or gas to enter and exit the bladder 232 based on a volume of the vapor 226 in the vapor storage tank 212. Here, the bladder 232 is shown more than half inflated meaning that the vapor volume of the vapor 226 in the vapor storage tank 212 is less than half.

The vapor treating assembly or subsystem 240 includes a liquid 242 disposed in a lower portion or section or heel of the vapor storage tank 212. The liquid 242 is withdrawn from the heel of the vapor storage tank 212 via a liquid recycle conduit 244. The liquid 242 recycled through the liquid recycle conduit 244 is pumped via a liquid pump 246 via a liquid inlet conduit 248 including a plurality of liquid sprayer devices 250, which produces streams of liquid droplets 252. The liquid droplet streams 252 are adapted to mix with or absorb a portion of the vapor 226 entering the vapor storage tank 212 via the vapor inlet conduit 214 through an equal plurality of orifices 214a disposed in the vapor inlet conduit 214 coincident with the liquid sprayer devices 250. The vapor treating assembly or subsystem 240 also includes a liquid level sensor device 254. The liquid level sensor device 254 includes a level sensor 254a, a sensor liquid conduit 254b, a liquid inlet port c, and a liquid outlet port 254d. The liquid inlet port 254c is disposed below a liquid level of the liquid 242 in the heel of the vapor storage tank 212, while the liquid outlet port 254d is disposed above the liquid level of the liquid 242 in the heel of the vapor storage tank 212. Make up or start up liquid is supplied via liquid supply conduit 256b.

The vapor treating assembly or subsystem 240 also includes an adjustment gas 262 supplied to the vapor storage tank 212 via an adjustment gas conduit 264c. The vapor treating assembly or subsystem 240 is designed to adjust the composition of the vapor 226 to a controlled composition using the liquid 226 and the adjustment gas 262. This controlled composition may be a BTU optimized vapor composition, a cleaned vapor composition, a BTU controlled vapor composition, or any other desired vapor composition.

The blower and sensor assembly or subsystem 270 includes a blower 272, a first flame arrestor 272a, an emergency venting device 272b associated with an intermediate vapor output conduit 216a, a vapor composition or BTU sensor 272c, and a second flame arrestor 272d associated with the vapor output conduit 216. The blower 272 is designed to create a steady-state controlled vapor output or vapor output stream.

The integrated vapor treating control assembly or subsystem 280 and a control and sensor assembly or subsystem 282. The control and sensor assembly or subsystem 282 includes bidirectional communication pathway 282a. The control and sensor assembly or subsystem 282 also includes one or more processing unit, memory, one or more mass storage devices, one or more input devices, one or more output devices, an operating system, routines for controlling the controllable devices of the apparatuses or system 200, and one or more sensor, e.g., temperature sensors, pressure sensors, any other sensor, or any combination thereof.

Referring now to FIG. 2C, another embodiment of an integrated vapor concentration adjustment and treatment apparatus or system, generally 200, includes a vapor storage assembly or subsystem 210 located on a ground location 202, a vapor supply assembly or subsystem 220, an integrated vapor concentration adjustment and treatment assembly or subsystem including an adjustable membrane assembly or subsystem 230, a vapor treating assembly or subsystem 240, a blower and sensor assembly or subsystem 270, and an integrated vapor treating control assembly or subsystem 280.

The vapor storage assembly or subsystem 210 includes a vapor storage tank 212 having a vapor inlet conduit 214, a vapor outlet conduit 216, and a vapor emission detector device 218. The vapor supply assembly or subsystem 220 includes a vapor source 222 and a vapor source control valve 224 that controls an amount of a vapor 226 being supplied from the vapor source 222 to the vapor storage tank 212.

The adjustable membrane assembly or subsystem 230 includes a conical ring type bladder 232 including a central weight 232a installed in an interior of the vapor storage tank 212 and anchored to a central location in the vapor storage tank 212 via a ring 232b. The adjustable membrane assembly or subsystem 230 also an air or gas vent conduit 234 and an air or gas vent 236 for air or gas to enter and exit the bladder 232 based on a volume of the vapor 226 in the vapor storage tank 212. The adjustable membrane assembly or subsystem 230 also include a tape type vapor level sensor 238a including a tape 238b, a tape type vapor level sensor conduit 238c anchored to the vapor tank 212 via mounts 238d and a Hi-Hi vapor level sensor 238e including a hanging member 238f and a member attachment 238g. Here, the bladder 232 is near minimum fill and the vapor volume is near a maximum.

The vapor treating assembly or subsystem 240 includes a liquid 242 disposed in a lower portion or section or heel of the vapor storage tank 212. The liquid 242 is withdrawn from the heel of the vapor storage tank 212 via a liquid recycle conduit 244. The liquid 242 recycled through the liquid recycle conduit 244 is pumped via a liquid pump 246 via a liquid inlet conduit 248 including a plurality of liquid sprayer devices 250, which produces streams of liquid droplets 252. The liquid droplet streams 252 are adapted to mix with or absorb a portion of the vapor 226 entering the vapor storage tank 212 via the vapor inlet conduit 214 through an equal plurality of orifices 214a disposed in the vapor inlet conduit 214 coincident with the liquid sprayer devices 250. The vapor treating assembly or subsystem 240 also includes a liquid level sensor device 254. The liquid level sensor device 254 includes a level sensor 254a, a sensor liquid conduit 254b, a liquid inlet port 254c, and a liquid outlet port 254d. The liquid inlet port 254c is disposed below a liquid level of the liquid 242 in the heel of the vapor storage tank 212, while the liquid outlet port 254d is disposed above the liquid level of the liquid 242 in the heel of the vapor storage tank 212. Make up or start up liquid is supplied via liquid supply conduit 256a.

The vapor treating assembly or subsystem 240 also includes an adjustment gas 262 supplied to the vapor storage tank 212 via the adjustment gas conduit 164c shown in FIG. 1D. The vapor treating assembly or subsystem 240 is designed to adjust the composition of the vapor 226 to a controlled composition using the liquid 226 and the adjustment gas 262. This controlled composition may be a BTU optimized vapor composition, a cleaned vapor composition, a BTU controlled vapor composition, or any other desired vapor composition.

The blower and sensor assembly or subsystem 270 includes a blower 272, a first flame arrestor 272a, an emergency venting device 272b associated with an intermediate vapor output conduit 216a, a vapor composition or BTU sensor 272c, and a second flame arrestor 272d associated with the vapor output conduit 216. The blower 272 is designed to create a steady-state controlled vapor output or vapor output stream.

The integrated vapor treating control assembly or subsystem 280 and a control and sensor assembly or subsystem 282. The control and sensor assembly or subsystem 282 includes bidirectional communication pathway 282a. The control and sensor assembly or subsystem 282 also includes one or more processing unit, memory, one or more mass storage devices, one or more input devices, one or more output devices, an operating system, routines for controlling the controllable devices of the apparatuses or system 200, and one or more sensor, e.g., temperature sensors, pressure sensors, any other sensor, or any combination thereof.

Referring now to FIG. 2D, another embodiment of an integrated vapor concentration adjustment and treatment apparatus or system, generally 200 includes a vapor storage assembly or subsystem 210 located on a ground location 202, a vapor supply assembly or subsystem 220, an integrated vapor concentration adjustment and treatment assembly or subsystem including an adjustable membrane assembly or subsystem 230, a vapor treating assembly or subsystem 240, a pipeline introduction and sensor assembly 276, and an integrated vapor treating control assembly or subsystem 280.

The vapor storage assembly or subsystem 210 includes a vapor storage tank 212 having a vapor inlet conduit 214, a vapor outlet conduit 216, and a vapor emission detector device 218. The vapor supply assembly or subsystem 220 includes a vapor source 222 and a vapor source control valve 224 that controls an amount of a vapor 226 being supplied from the vapor source 222 to the vapor storage tank 212.

The adjustable membrane assembly or subsystem 230 includes a conical ring type bladder 232 including a central weight 232a installed in an interior of the vapor storage tank 212 and anchored to a central location in the vapor storage tank 212 via a ring 232b. The adjustable membrane assembly or subsystem 230 also an air or gas vent conduit 234 and an air or gas vent 236 for air or gas to enter and exit the bladder 232 based on a volume of the vapor 226 in the vapor storage tank 212. The adjustable membrane assembly or subsystem 230 also include a tape type vapor level sensor 238a including a tape 238b, a tape type vapor level sensor conduit 238c anchored to the vapor tank 212 via mounts 238d and a Hi-Hi vapor level sensor 238e including a hanging member 238f and a member attachment 238g. Here, the bladder 232 is near maximum fill and the vapor volume is near a minimum.

The vapor treating assembly or subsystem 240 includes a liquid 242 disposed in a lower portion or section or heel of the vapor storage tank 212. The liquid 242 is withdrawn from the heel of the vapor storage tank 212 via a liquid recycle conduit 244. The liquid 242 recycled through the liquid recycle conduit 244 is pumped via a liquid pump 246 via a liquid inlet conduit 248 including a plurality of liquid sprayer devices 250, which produces streams of liquid droplets 252. The liquid droplet streams 252 are adapted to mix with or absorb a portion of the vapor 226 entering the vapor storage tank 212 via the vapor inlet conduit 214 through an equal plurality of orifices 214a disposed in the vapor inlet conduit 214 coincident with the liquid sprayer devices 250. The vapor treating assembly or subsystem 240 also includes a liquid level sensor device 254. The liquid level sensor device 254 includes a level sensor 254a, a sensor liquid conduit 254b, a liquid inlet port 254c, and a liquid outlet port 254d. The liquid inlet port 254c is disposed below a liquid level of the liquid 242 in the heel of the vapor storage tank 212, while the liquid outlet port d is disposed above the liquid level of the liquid 242 in the heel of the vapor storage tank 212. Make up or start up liquid is supplied via liquid supply conduit 256b.

The vapor treating assembly or subsystem 240 also includes an adjustment gas 262 supplied to the vapor storage tank 212 via an adjustment gas conduit 264c. The vapor treating assembly or subsystem 240 is designed to adjust the composition of the vapor 226 to a controlled composition using the liquid 226 and the adjustment gas 262. This controlled composition may be a BTU optimized vapor composition, a cleaned vapor composition, a BTU controlled vapor composition, or any other desired vapor composition.

The pipeline introduction and sensor assembly 276 includes a gas compression unit 278, a first flame arrestor 278a, an emergency venting device 278b associated with an intermediate vapor output conduit 216a, a vapor composition or BTU sensor 278c, and a pipeline introduction valve 278d associated with the vapor output conduit 216. The gas compression unit 278 is designed to create a steady-state controlled vapor output or vapor output stream at the pipeline pressure and composition.

The integrated vapor treating control assembly or subsystem 280 and a control and sensor assembly or subsystem 282. The control and sensor assembly or subsystem 282 includes bidirectional communication pathway 282a. The control and sensor assembly or subsystem 282 also includes one or more processing unit, memory, one or more mass storage devices, one or more input devices, one or more output devices, an operating system, routines for controlling the controllable devices of the apparatuses or system 200, and one or more sensor, e.g., temperature sensors, pressure sensors, any other sensor, or any combination thereof.

Unlike the embodiments of FIGS. 2A, 2B and 2C, the present embodiment is designed to produce a vapor composition that may be added to other similar vapor streams. For example, if the input vapor is basically methane or some other contaminated useable petroleum gas, the vapor produced by the integrated gas storage and vapor treatment assembly or subsystem 282 may be added to existing pipelines carrying the petroleum gas. In such cases, the vapor output sensor and pressure and temperature adjustment assembly or subsystem 284x may also include one or more pumps, one or more compressors, one or more control valve, and one or more flow controllers so that the purified vapor may be added to any pipeline regardless of the pressure.

The integrated vapor treating control assembly or subsystem 280 of FIGS. 2A-D are configured to receive data from the various sensors associated with the apparatuses or systems 200, especially the vapor composition sensors, the BTU sensors, the liquid level sensors, the vapor level sensors, the temperature sensors, and the pressures sensors and to send instructions to the flow control valves, the blower assembly, and the pumps or the compressors assembly. The instructions send by the integrated vapor treating control assembly or subsystem 280 are configured to control an effluent or output composition of the vapor for subsequent use such as incineration abatement, pipeline injection, or other abatement uses and to control an effluent or output volumetric flow rate of the effluent or output composition of the vapor, so that the effluent or output volumetric flow rate is steady and controlled both for abatement and pipeline injection. Additionally, for uses that require removal of contaminates from the vapor, the integrated vapor treating control assembly or subsystem 280 are also configured to control the injection of scavengers into the vapor and to control the removal of contaminates from the liquid, especially for pipeline injection or other similar uses.

It should be recognized that the integrated vapor treating control assembly or subsystem 280 of FIGS. 2A-D may be located in an onsite facility or an offsite facility. The onsite facility may be a separate building or housed in a facility associated with the vapor supply facility or the vapor abatement facility or the pipeline operation facility. The offsite facility may be located in a building or operated from any remote location having internet access.

### Embodiments of the Disclosure

Embodiment 1. An apparatus comprising:
a vapor storage assembly configured to store a vapor;
an integrated vapor concentration adjustment and treatment assembly including:
   an adjustable membrane assembly disposed in an interior of a vapor storage tank and configured to adjust to a volume of the vapor in the vapor storage tank;
a vapor treating assembly disposed in and on a lower portion of the vapor storage tank and configured to adjust a vapor composition of the vapor in the vapor storage tank to produce an effluent or output vapor;
a blower and sensor assembly configured to control a flow rate of the effluent or output vapor; and
an integrated vapor treating control assembly configured to control the assemblies to produce the effluent or output vapor and the effluent or output vapor flow rate.

Embodiment 2. The Embodiment of Embodiments 1, further comprising an abatement or incineration assembly configured to incinerate the effluent or output vapor.

Embodiment 3. The Embodiment of Embodiments 1 through 2, wherein the vapor storage assembly includes:
a vapor storage tank,
a vapor inlet conduit,
a vapor output conduit, and
a vapor source including a vapor flow control valve.

Embodiment 4. The Embodiment of Embodiments 1 through 3, wherein the adjustable membrane assembly includes:
a bladder including an air or gas conduit and an air or gas vent configured to allow air or gas to enter and exit the bladder based on a volume of the vapor in the vapor storage tank.

Embodiment 5. The Embodiment of Embodiments 1 through 4, wherein the vapor treating assembly includes:
a liquid disposed in a lower portion or section or heel of the vapor storage tank,
a liquid recycle conduit configured to withdraw the liquid from the heel of the vapor storage tank,
a liquid pump configured to pump the withdrawn liquid,
a liquid inlet conduit including one or more liquid sprayer devices configured to produce a stream of liquid droplets or atomized particles, wherein the liquid droplets or atomized particles mix with or absorb a portion of the vapor entering the vapor storage tank,
a liquid level sensor device configured to measure a level of the liquid in the heel of the storage tank,
a liquid source including a liquid control valve configured to supply the liquid to make up for liquid losses or at start up to fill the heel of the vapor storage tank with liquid via a filling conduit, and
an adjustment gas source including an adjustment gas control valve, an adjustment gas pump, and an adjustment gas conduit configured to supply an adjustment gas to the vapor storage tank to assist in adjusting a composition of the vapor in the vapor storage tank,
wherein the vapor treating assembly or subsystem is designed to adjust a composition of the vapor to a controlled composition using the liquid and the adjustment gas,

Embodiment 6. The Embodiment of Embodiment 5, wherein the controlled composition may be a BTU optimized vapor composition, a cleaned vapor composition, a BTU controlled vapor composition, or any other desired vapor composition.

Embodiment 7. The Embodiment of Embodiments 1 through 6, wherein the blower and sensor assembly includes a blower, a first flame arrestor, an emergency venting device associated with an intermediate vapor output conduit, a vapor composition or BTU sensor, and a second flame arrestor associated with the vapor output conduit, wherein the blower is configured to create a steady-state controlled vapor output or vapor volume output stream.

Embodiment 8. The Embodiment of Embodiments 1 through 7, wherein the integrated vapor treating control assembly comprising one or more processing unit, memory, one or more mass storage devices, one or more input devices, one or more output devices, an operating system, routines for controlling the controllable devices and sensor of the apparatus.

Embodiment 9. The Embodiment of Embodiment 8, wherein the integrated vapor treating control assembly is configured to:
receive data from the vapor composition sensors, BTU sensors, liquid level sensors, vapor level sensors, temperature sensors, and pressures sensors and
send instructions to the flow control valves, the blower assembly, and the pumps or the compressors assembly to control an effluent or output composition of the vapor for subsequent use such as incineration abatement, pipeline injection, or other abatement uses and to control an effluent or output volumetric flow rate of the effluent or output composition of the vapor, so that the effluent or output volumetric flow rate is steady and controlled both for abatement and pipeline injection.

Embodiment 10. The Embodiment of Embodiment 9, wherein, for uses that require removal of contaminates from the vapor, the integrated vapor treating control assembly or subsystem is also configured to control the injection of scavengers into the vapor and to control the removal of contaminates from the liquid, especially for pipeline injection or other similar uses.

Embodiment 11. An apparatus comprising:
a vapor storage assembly configured to store a vapor;
an integrated vapor concentration adjustment and treatment assembly including:
   an adjustable membrane assembly disposed in an interior of a vapor storage tank and configured to adjust to a volume of the vapor in the vapor storage tank;
a vapor treating assembly disposed in and on a lower portion of the vapor storage tank and configured to adjust a vapor composition of the vapor in the vapor storage tank to produce an effluent or output vapor;
a pipeline introduction and sensor assembly configured to introduce the effluent or output vapor into the pipeline; and
   an integrated vapor treating control assembly configured to control the assemblies to produce the effluent or output vapor and the effluent or output vapor flow rate.

Embodiment 12. The Embodiment of Embodiments 11, further comprising an abatement or incineration assembly configured to incinerate the effluent or output vapor.

Embodiment 13. The Embodiment of Embodiments 11 through 12, wherein the vapor storage assembly includes:
a vapor storage tank,
a vapor inlet conduit,
a vapor output conduit, and
a vapor source including a vapor flow control valve.

Embodiment 14. The Embodiment of Embodiments 11 through 13, wherein the adjustable membrane assembly includes:
a bladder including an air or gas conduit and an air or gas vent configured to allow air or gas to enter and exit the bladder based on a volume of the vapor in the vapor storage tank.

Embodiment 15. The Embodiment of Embodiments 11 through 14, wherein the vapor treating assembly includes:
a liquid disposed in a lower portion or section or heel of the vapor storage tank,
a liquid recycle conduit configured to withdraw the liquid from the heel of the vapor storage tank,
a liquid pump configured to pump the withdrawn liquid,
a liquid inlet conduit including one or more liquid sprayer devices configured to produce a stream of liquid droplets or atomized particles, wherein the liquid droplets or atomized particles mix with or absorb a portion of the vapor entering the vapor storage tank,
a liquid level sensor device configured to measure a level of the liquid in the heel of the storage tank,
a liquid source including a liquid control valve configured to supply the liquid to make up for liquid losses or at start up to fill the heel of the vapor storage tank with liquid via a filling conduit, and
an adjustment gas source including an adjustment gas control valve, an adjustment gas pump, and an adjustment gas conduit configured to supply an adjustment gas to the vapor storage tank to assist in adjusting a composition of the vapor in the vapor storage tank,
wherein the vapor treating assembly or subsystem is designed to adjust a composition of the vapor to a controlled composition using the liquid and the adjustment gas,

Embodiment 16. The Embodiment of Embodiment 15, wherein the controlled composition may be a BTU optimized vapor composition, a cleaned vapor composition, a BTU controlled vapor composition, or any other desired vapor composition.

Embodiment 17. The Embodiment of Embodiments 11 through 16, wherein the blower and sensor assembly includes a blower, a first flame arrestor, an emergency venting device associated with an intermediate vapor output conduit, a vapor composition or BTU sensor, and a second flame arrestor associated with the vapor output conduit, wherein the blower is configured to create a steady-state controlled vapor output or vapor volume output stream.

Embodiment 18. The Embodiment of Embodiments 11 through 17, wherein the integrated vapor treating control assembly comprising one or more processing unit, memory, one or more mass storage devices, one or more input devices, one or more output devices, an operating system, routines for controlling the controllable devices and sensor of the apparatus.

Embodiment 19. The Embodiment of Embodiment 18, wherein the integrated vapor treating control assembly is configured to:
receive data from the vapor composition sensors, BTU sensors, liquid level sensors, vapor level sensors, temperature sensors, and pressures sensors and
send instructions to the flow control valves, the blower assembly, and the pumps or the compressors assembly to control an effluent or output composition of the vapor for subsequent use such as incineration abatement, pipeline injection, or other abatement uses and to control an effluent or output volumetric flow rate of the effluent or output composition of the vapor, so that the effluent or output volumetric flow rate is steady and controlled both for abatement and pipeline injection.

Embodiment 20. The Embodiment of Embodiment 19, wherein for uses that require removal of contaminates from the vapor, the integrated vapor treating control assembly or subsystem is also configured to control the injection of scavengers into the vapor and to control the removal of contaminates from the liquid, especially for pipeline injection or other similar uses.

Embodiment 21. A system comprising:
a vapor storage subsystem configured to store a vapor;
an integrated vapor concentration adjustment and treatment subsystem including:
   an adjustable membrane subsystem disposed in an interior of a vapor storage tank and configured to adjust to a volume of the vapor in the vapor storage tank;
a vapor treating subsystem disposed in and on a lower portion of the vapor storage tank and configured to adjust a vapor composition of the vapor in the vapor storage tank to produce an effluent or output vapor;
a blower and sensor subsystem configured to control a flow rate of the effluent or output vapor; and
an integrated vapor treating control subsystem configured to control the subsystems to produce the effluent or output vapor and the effluent or output vapor flow rate.

Embodiment 22. The Embodiment of Embodiments 21, further comprising an abatement or incineration subsystem configured to incinerate the effluent or output vapor.

Embodiment 23. The Embodiment of Embodiments 21 through 22, wherein the vapor storage subsystem includes:
a vapor storage tank,
a vapor inlet conduit,
a vapor output conduit, and
a vapor source including a vapor flow control valve.

Embodiment 24. The Embodiment of Embodiments 21 through 23, wherein the adjustable membrane subsystem includes:
a bladder including an air or gas conduit and an air or gas vent configured to allow air or gas to enter and exit the bladder based on a volume of the vapor in the vapor storage tank.

Embodiment 25. The Embodiment of Embodiments 21 through 24, wherein the vapor treating subsystem includes:
a liquid disposed in a lower portion or section or heel of the vapor storage tank,
a liquid recycle conduit configured to withdraw the liquid from the heel of the vapor storage tank,
a liquid pump configured to pump the withdrawn liquid,
a liquid inlet conduit including one or more liquid sprayer devices configured to produce a stream of liquid droplets or atomized particles, wherein the liquid droplets or atomized particles mix with or absorb a portion of the vapor entering the vapor storage tank,
a liquid level sensor device configured to measure a level of the liquid in the heel of the storage tank,
a liquid source including a liquid control valve configured to supply the liquid to make up for liquid losses or at start up to fill the heel of the vapor storage tank with liquid via a filling conduit, and
an adjustment gas source including an adjustment gas control valve, an adjustment gas pump, and an adjustment gas conduit configured to supply an adjustment gas to the vapor storage tank to assist in adjusting a composition of the vapor in the vapor storage tank,
wherein the vapor treating subsystem or subsystem is designed to adjust a composition of the vapor to a controlled composition using the liquid and the adjustment gas,

Embodiment 26. The Embodiment of Embodiment 25, wherein the controlled composition may be a BTU optimized vapor composition, a cleaned vapor composition, a BTU controlled vapor composition, or any other desired vapor composition.

Embodiment 27. The Embodiment of Embodiments 21 through 26, wherein the blower and sensor subsystem includes a blower, a first flame arrestor, an emergency venting device associated with an intermediate vapor output conduit, a vapor composition or BTU sensor, and a second flame arrestor associated with the vapor output conduit, wherein the blower is configured to create a steady-state controlled vapor output or vapor volume output stream.

Embodiment 28. The Embodiment of Embodiments 21 through 27, wherein the integrated vapor treating control subsystem comprising one or more processing unit, memory, one or more mass storage devices, one or more input devices, one or more output devices, an operating system, routines for controlling the controllable devices and sensor of the apparatus.

Embodiment 29. The Embodiment of Embodiment 28, wherein the integrated vapor treating control subsystem is configured to:
receive data from the vapor composition sensors, BTU sensors, liquid level sensors, vapor level sensors, temperature sensors, and pressures sensors and
send instructions to the flow control valves, the blower subsystem, and the pumps or the compressors subsystem to control an effluent or output composition of the vapor for subsequent use such as incineration abatement, pipeline injection, or other abatement uses and to control an effluent or output volumetric flow rate of the effluent or output composition of the vapor, so that the effluent or output volumetric flow rate is steady and controlled both for abatement and pipeline injection.

Embodiment 30. The Embodiment of Embodiment 29, wherein for uses that require removal of contaminates from the vapor, the integrated vapor treating control subsystem or subsystem is also configured to control the injection of scavengers into the vapor and to control the removal of contaminates from the liquid, especially for pipeline injection or other similar uses.

Embodiment 31. A system comprising:
a vapor storage subsystem configured to store a vapor;
an integrated vapor concentration adjustment and treatment subsystem including:
   an adjustable membrane subsystem disposed in an interior of a vapor storage tank and configured to adjust to a volume of the vapor in the vapor storage tank;
a vapor treating subsystem disposed in and on a lower portion of the vapor storage tank and configured to adjust a vapor composition of the vapor in the vapor storage tank to produce an effluent or output vapor;
a pipeline introduction and sensor subsystem configured to introduce the effluent or output vapor into the pipeline; and
   an integrated vapor treating control subsystem configured to control the subsystems to produce the effluent or output vapor and the effluent or output vapor flow rate.

Embodiment 32. The Embodiment of Embodiments 31, further comprising an abatement or incineration subsystem configured to incinerate the effluent or output vapor.

Embodiment 33. The Embodiment of Embodiments 31 through 32, wherein the vapor storage subsystem includes:
a vapor storage tank,
a vapor inlet conduit,
a vapor output conduit, and
a vapor source including a vapor flow control valve.

Embodiment 34. The Embodiment of Embodiments 31 through 33, wherein the adjustable membrane subsystem includes:
a bladder including an air or gas conduit and an air or gas vent configured to allow air or gas to enter and exit the bladder based on a volume of the vapor in the vapor storage tank.

Embodiment 35. The Embodiment of Embodiments 31 through 34, wherein the vapor treating subsystem includes:
a liquid disposed in a lower portion or section or heel of the vapor storage tank,
a liquid recycle conduit configured to withdraw the liquid from the heel of the vapor storage tank,
a liquid pump configured to pump the withdrawn liquid,
a liquid inlet conduit including one or more liquid sprayer devices configured to produce a stream of liquid droplets or atomized particles, wherein the liquid droplets or atomized particles mix with or absorb a portion of the vapor entering the vapor storage tank,
a liquid level sensor device configured to measure a level of the liquid in the heel of the storage tank,
a liquid source including a liquid control valve configured to supply the liquid to make up for liquid losses or at start up to fill the heel of the vapor storage tank with liquid via a filling conduit, and
an adjustment gas source including an adjustment gas control valve, an adjustment gas pump, and an adjustment gas conduit configured to supply an adjustment gas to the vapor storage tank to assist in adjusting a composition of the vapor in the vapor storage tank,
wherein the vapor treating subsystem or subsystem is designed to adjust a composition of the vapor to a controlled composition using the liquid and the adjustment gas,

Embodiment 36. The Embodiment of Embodiment 35, wherein the controlled composition may be a BTU optimized vapor composition, a cleaned vapor composition, a BTU controlled vapor composition, or any other desired vapor composition.

Embodiment 37. The Embodiment of Embodiments 31 through 36, wherein the blower and sensor subsystem includes a blower, a first flame arrestor, an emergency venting device associated with an intermediate vapor output conduit, a vapor composition or BTU sensor, and a second flame arrestor associated with the vapor output conduit, wherein the blower is configured to create a steady-state controlled vapor output or vapor volume output stream.

Embodiment 38. The Embodiment of Embodiments 10 through 37, wherein the integrated vapor treating control subsystem comprising one or more processing unit, memory, one or more mass storage devices, one or more input devices, one or more output devices, an operating system, routines for controlling the controllable devices and sensor of the apparatus.

Embodiment 39. The Embodiment of Embodiment 38, wherein the integrated vapor treating control subsystem is configured to:
receive data from the vapor composition sensors, BTU sensors, liquid level sensors, vapor level sensors, temperature sensors, and pressures sensors and
send instructions to the flow control valves, the blower subsystem, and the pumps or the compressors subsystem to control an effluent or output composition of the vapor for subsequent use such as incineration abatement, pipeline injection, or other abatement uses and to control an effluent or output volumetric flow rate of the effluent or output composition of the vapor, so that the effluent or output volumetric flow rate is steady and controlled both for abatement and pipeline injection.

Embodiment 40. The Embodiment of Embodiment 39, wherein for uses that require removal of contaminates from the vapor, the integrated vapor treating control subsystem or subsystem is also configured to control the injection of scavengers into the vapor and to control the removal of contaminates from the liquid, especially for pipeline injection or other similar uses.

Embodiment 41. A method comprising:
receiving data from the vapor composition sensors, BTU sensors, liquid level sensors, vapor level sensors, temperature sensors, and pressures sensors and
sending instructions to the flow control valves, the blower assembly, and the pumps or the compressors assembly to control an effluent or output composition of the vapor for subsequent use such as incineration abatement, pipeline injection, or other abatement uses and to control an effluent or output volumetric flow rate of the effluent or output composition of the vapor, so that the effluent or output volumetric flow rate is steady and controlled both for abatement and pipeline injection.

Embodiment 42. A method comprising:
installing an integrated vapor concentration adjustment and treatment apparatus or system into a tank of a vapor storage assembly or subsystem, and
installing an integrated vapor treating control assembly.

Embodiment 43. A method comprising:
filling a lower section of the tank with a liquid from a liquid source;
filling a vapor storage tank of a vapor storage assembly with a vapor from a vapor source;
as the vapor storage tank is being filled with the vapor, simultaneously adjusting a gas storage assembly disposed in an interior of the vapor storage tank;
withdrawing the liquid from the lower section of the vapor storage tank;
injecting the withdrawn liquid into the vapor in the vapor storage tank, simultaneously or sequentially injecting an adjustment gas from an adjustment gas source into the vapor storage tank, and optionally simultaneously or sequentially injecting one or more vapor purifying materials from a vapor purifying material source into the vapor storage tank to form an output vapor having a desired output vapor composition; and
supplying the output vapor either to an abatement or incineration assembly or subsystem at a controlled pressure and flow rate or to a pipeline introduction and sensor assembly at a controlled temperature, pressure, and flow rate.

Embodiment 44. The Embodiments of any of the previous Embodiments, wherein the durable lightweight flexible material with a low permeability and long-term stability to the or fluid vapors being stored, such as gasoline and gasoline vapor, diesel and diesel vapor, any other hydrocarbon fluid and its vapor, other fluids and their vapor, or mixtures or combinations thereof.

Embodiment 45. The Embodiments of any of the previous Embodiments, wherein the vapors for use in this disclosure include, without limitation, hydrocarbon gases, contaminated hydrocarbon gases, hydrocarbon fuels, contaminated hydrocarbon fuels, other flammable gases, other contaminated flammable gases, non-flammable gases, contaminated non-flammable gases, or any other gas that need to be stored and properties modified or adjusted prior to subsequent use.

Embodiment 46. The Embodiment of Embodiment 45, wherein the flammable vapors include methane, contaminated methane, natural gas, contaminated natural gas, sour natural gas, ethane, contaminated ethane, propane, contaminated propane, other hydrocarbon fuels, or other contaminated hydrocarbon fuels.

Embodiment 47. The Embodiment of Embodiment 46, wherein the flammable vapors for use in this disclosure include, without limitation, methane, natural gas, ethane, propane, gasoline, diesel, or other hydrocarbon fuels.

Embodiment 48. The Embodiments of any of the previous Embodiments, wherein the liquids include gasoline, diesel, methanol, ethanol, MTBE, benzene, toluene, other hydrocarbon fluids, any other liquid necessary for the treatment of the incoming vapor stream, or mixtures thereof.

Embodiment 49. The Embodiments of any of the previous Embodiments, wherein the adjustment gases include hydrocarbon gases, gaseous hydrocarbon fuels, other flammable gases, non-flammable gases, or mixtures thereof.

Embodiment 50. The Embodiment of Embodiment 49, wherein the adjustment gases for use in this disclosure include, without limitation, methane, natural gas, ethane, propane, or mixtures thereof.

Embodiment 51. The Embodiment of Embodiment 49, wherein for non-flammable vapors, the adjustment gases are designed to adjust the composition of the non-flammable vapor prior to subsequent use.

Embodiment 52. The Embodiments of any of the previous Embodiments, wherein the gases include air, a non-flammable gas, or any mixture thereof.

Embodiment 53. The Embodiment of Embodiment 52, wherein the non-flammable gas includes nitrogen, carbon dioxide, argon, freon, any other non-flammable gas, or mixtures thereof.

Embodiment 54. The Embodiments of any of the previous Embodiments, wherein the scavengers or scavenging agents include sulfur scavengers or scavenging agents (i.e., scavengers or scavenging agents for hydrogen sulfide), hydrogen cyanide scavengers or scavenging agents, carbon dioxide scavengers or scavenging agents, any other scavengers or scavenging agents used to clean hydrocarbon gases such as methane, natural gas, or propane.

Embodiment 55. The Embodiments of any of the previous Embodiments, wherein the liquid pumps include axial type liquid pumps, mixed type liquid pumps, radial type liquid pumps, electromagnetic type liquid pumps, jet type liquid pumps, gear type liquid pumps, peristaltic type liquid pumps, rotary vane type liquid pumps, screw type liquid pumps, diaphragm type liquid pumps, piston/plunger type liquid pumps, or any other type pump capable pumping a liquid.

Embodiment 56. The Embodiments of any of the previous Embodiments, wherein the liquid flow control valves include ball valves, butterfly valves, gate valves, globe valves, diaphragm valves,
piston valves, any other type of flow control valve for controlling a liquid flow rate, or combinations thereof.

Embodiment 57. The Embodiments of any of the previous Embodiments, wherein the gas flow control valves for use in this disclosure include, without limitation, ball valves, butterfly valves, gate valves, globe valves, diaphragm valves, piston valves, any other type of flow control valve for controlling a gas flow rate, or combinations thereof.

Embodiment 58. The Embodiments of any of the previous Embodiments, wherein the pressure sensors include aneroid barometer pressure sensors, manometer pressure sensors, bourdon tube pressure sensors, vacuum pressure sensors, sealed pressure sensors, piezoelectric pressure sensors, strain gauge pressure sensors, or any combination thereof.

Embodiment 59. The Embodiments of any of the previous Embodiments, wherein the temperature sensors include thermocouple devices, resistance temperature detection devices, thermistor devices, semiconductor-based IC devices, or any combination thereof.

Embodiment 60. The Embodiments of any of the previous Embodiments, wherein the composition sensors include potentiometric sensors, amperometric sensors, impedimetric sensors, or any combination thereof.

Embodiment 61. The Embodiments of any of the previous Embodiments, wherein the BTU sensors include mechanical heat meter sensors, heat meter using ultrasound sensors, electrical heat meter sensors, electrochemical gas sensor, catalytic gas sensor, infrared gas sensor, photoionization gas sensor. or any combination thereof.

Embodiment 62. The Embodiments of any of the previous Embodiments, wherein the liquid and/or gas level sensors include air bubbler level sensors, capacitive level sensors, differential pressure level sensors, electrical conductivity or resistance level sensors, mechanical or magnetic float level sensors, optical level sensors, pressure membrane level sensors, radar or microwave level sensors, radio frequency (RF) level sensors, sonic or ultrasonic level sensors, retractable tape level sensors, Hi-Hi switch level sensors, tuning fork level sensors, any other level sensor, or any combination thereof.

Embodiment 63. The Embodiments of any of the previous Embodiments, wherein the software systems, software products, and/or software objects include any analog or digital processing unit or units having single or a plurality of software products installed thereon.

Embodiment 64. The Embodiment of Embodiment 63, wherein the software products include operating systems, graphics systems, business software systems, word processor systems, business systems, online merchandising, online merchandising systems, purchasing and business transaction systems, databases, software programs and applications, internet browsers, accounting systems, military systems, control systems, or mixtures or combinations thereof.

Embodiment 65. The Embodiments of any of the previous Embodiments, wherein the processing units include programmable logic controllers (PLCs), human machine interface (HMIs), digital processing units (DPUs), analog processing units (APUs), Field Programmable Gate Arrays (FPGAs), any other technology that may receive motion sensor output and generate command and/or control functions for objects under the control of the processing unit, and/or mixtures and combinations thereof.

Embodiment 66. The Embodiment of Embodiment 65, wherein the PLCs and HMIs include General Electric (GE), Rockwell Automation, Siemens, Automation Direct, Fuji, Schneider Electric, ABB, Omron, Modicon, Mitsubishi, Red Lion.

Embodiment 67. The Embodiment of Embodiment 65, wherein the DPUs include any digital processing unit capable of accepting input from a plurality of devices and converting at least some of the input into output designed to select and/or control attributes of one or more of the devices.

Embodiment 68. The Embodiment of Embodiment 67, wherein the DPUs include microprocessor, microcontrollers, or the like manufactured by Intel, Motorola, Ericsson, HP, Samsung, Hitachi, NRC, Applied Materials, AMD, Cyrix, Sun Microsystem, Philips, National Semiconductor, Qualcomm, or any other manufacture of microprocessors or microcontrollers, or mixtures or combinations thereof.

Embodiment 69. The Embodiment of Embodiment 67, wherein the APUs include any analog processing unit capable of accepting input from a plurality of devices and converting at least some of the input into output designed to control attributes of one or more of the devices.

Embodiment 70. The Embodiment of Embodiment 69, wherein the APUs available from Analog Devices Inc.

Embodiment 71. The Embodiments of any of the previous Embodiments, wherein the input and output devices include cathode ray tubes, liquid crystal displays, light emitting diode displays, organic light emitting diode displays, plasma displays, touch screens, touch sensitive input/output devices, audio input/output devices, audio-visual input/output devices, holographic displays and environments, keyboard input devices, mouse input devices, optical input devices, eye-tracking devices, head-tracking devices, hand-tracking devices, body-tracking devices, any other input and/or output device that permits a user to receive user intended inputs and generated output signals, or any combination thereof.

### CLOSING PARAGRAPH OF THE DISCLOSURE

All references cited herein are incorporated by reference. Although the disclosure has been disclosed with reference to its preferred embodiments, from reading this description those of skill in the art may appreciate changes and modification that may be made which do not depart from the scope and spirit of the disclosure as described above and claimed hereafter.

1. An apparatus comprising:
a vapor storage assembly; and
an integrated vapor concentration adjustment and treatment assembly including:
an adjustable membrane assembly disposed in an interior of a vapor storage tank and configured to adjust to a volume of the vapor in the vapor storage tank;
a vapor treating assembly disposed in and on a lower portion of the vapor storage tank and configured to adjust a vapor composition of the vapor in the vapor storage tank;
a blower and sensor assembly; and
an integrated vapor treating control assembly.

2. The apparatus of claim 1, further comprising an abatement or incineration subsystem.

3. The apparatus of claim 1, further comprising a pipeline.

4. The apparatus of claim 1, wherein the durable lightweight flexible material with a low permeability and long-term stability to the or fluid vapors being stored, such as gasoline and gasoline vapor, diesel and diesel vapor, any other hydrocarbon fluid and its vapor, other fluids and their vapor, or mixtures or combinations thereof.

5. The apparatus of claim 1, wherein:
the vapors for use in this disclosure include, without limitation, hydrocarbon gases, contaminated hydrocarbon gases, hydrocarbon fuels, contaminated hydrocarbon fuels, other flammable gases, other contaminated flammable gases, non-flammable gases, contaminated non-flammable gases, or any other gas that need to be stored and properties modified or adjusted prior to subsequent use;
the liquids include gasoline, diesel, methanol, ethanol, MTBE, benzene, toluene, other hydrocarbon fluids, any other liquid necessary for the treatment of the incoming vapor stream, or mixtures thereof;
the adjustment gases include hydrocarbon gases, gaseous hydrocarbon fuels, other flammable gases, non-flammable gases, or mixtures thereof; and
the gases include air, a non-flammable gas, or any mixture thereof.

6. The apparatus of claim 1, wherein the scavengers or scavenging agents include sulfur scavengers or scavenging agents, hydrogen cyanide scavengers or scavenging agents, carbon dioxide scavengers or scavenging agents, any other scavengers or scavenging agents used to clean hydrocarbon gases such as methane, natural gas, or propane.

7. The apparatus of claim 6, wherein:
the flammable vapors include methane, contaminated methane, natural gas, contaminated natural gas, sour natural gas, ethane, contaminated ethane, propane, contaminated propane, other hydrocarbon fuels, or other contaminated hydrocarbon fuels;
the adjustment gases include hydrocarbon gases, gaseous hydrocarbon fuels, other flammable gases, non-flammable gases, or mixtures thereof;
for non-flammable vapors, the adjustment gases are designed to adjust the composition of the non-flammable vapor prior to subsequent use; and
the gases include air, a non-flammable gas, or any mixture thereof.

8. The apparatus of claim 7, wherein:
the flammable vapors for use in this disclosure include, without limitation, methane, natural gas, ethane, propane, gasoline, diesel, or other hydrocarbon fuels;
the adjustment gases for use in this disclosure include, without limitation, methane, natural gas, ethane, propane, or mixtures thereof; and
the non-flammable gas includes nitrogen, carbon dioxide, argon, a freon, any other non-flammable gas, or mixtures thereof.

9. The apparatus of claim 1, wherein:
the liquid pumps include axial type liquid pumps, mixed type liquid pumps, radial type liquid pumps, electromagnetic type liquid pumps, jet type liquid pumps, gear type liquid pumps, peristaltic type liquid pumps, rotary vane type liquid pumps, screw type liquid pumps, diaphragm type liquid pumps, piston/plunger type liquid pumps, or any other type pump capable pumping a liquid;
the liquid flow control valves include ball valves, butterfly valves, gate valves, globe valves, diaphragm valves, piston valves, any other type of flow control valve for controlling a liquid flow rate, or combinations thereof;
the gas flow control valves for use in this disclosure include, without limitation, ball valves, butterfly valves, gate valves, globe valves, diaphragm valves, piston valves, any other type of flow control valve for controlling a gas flow rate, or combinations thereof;
the pressure sensors include aneroid barometer pressure sensors, manometer pressure sensors, bourdon tube pressure sensors, vacuum pressure sensors, sealed pressure sensors, piezoelectric pressure sensors, strain gauge pressure sensors, or any combination thereof;
the temperature sensors include thermocouple devices, resistance temperature detection devices, thermistor devices, semiconductor based IC devices, or any combination thereof;
the composition sensors include potentiometric sensors, amperometric sensors, impedimetric sensors, or any combination thereof;
the BTU sensors include mechanical heat meter sensors, heat meter using ultrasound sensors, electrical heat meter sensors, electrochemical gas sensor, catalytic gas sensor, infrared gas sensor, photoionization gas sensor. or any combination thereof; and
the liquid and/or gas level sensors include air bubbler level sensors, capacitive level sensors, differential pressure level sensors, electrical conductivity or resistance level sensors, mechanical or magnetic float level sensors, optical level sensors, pressure membrane level sensors, radar or microwave level sensors, radio frequency (RF) level sensors, sonic or ultrasonic level sensors, retractable tape level sensors, Hi-Hi switch level sensors, tuning fork level sensors, any other level sensor, or any combination thereof.

10. An apparatus comprising:
a vapor storage assembly; and
an integrated vapor concentration adjustment and treatment assembly including:
an adjustable membrane assembly disposed in an interior of a vapor storage tank and configured to adjust to a volume of the vapor in the vapor storage tank;
a vapor treating assembly disposed in and on a lower portion of the vapor storage tank and configured to adjust a vapor composition of the vapor in the vapor storage tank;
a pipeline introduction and sensor assembly; and
an integrated vapor treating control assembly.

11. The apparatus of claim 10, further comprising an abatement or incineration subsystem.

12. The apparatus of claim 10, further comprising a pipeline.

13. The apparatus of claim 10, wherein the durable lightweight flexible material with a low permeability and long-term stability to the or fluid vapors being stored, such as gasoline and gasoline vapor, diesel and diesel vapor, any other hydrocarbon fluid and its vapor, other fluids and their vapor, or mixtures or combinations thereof.

14. The apparatus of claim 10, wherein:
the vapors for use in this disclosure include, without limitation, hydrocarbon gases, contaminated hydrocarbon gases, hydrocarbon fuels, contaminated hydrocarbon fuels, other flammable gases, other contaminated flammable gases, non-flammable gases, contaminated non-flammable gases, or any other gas that need to be stored and properties modified or adjusted prior to subsequent use;
the liquids include gasoline, diesel, methanol, ethanol, MTBE, benzene, toluene, other hydrocarbon fluids, any other liquid necessary for the treatment of the incoming vapor stream, or mixtures thereof;
the adjustment gases include hydrocarbon gases, gaseous hydrocarbon fuels, other flammable gases, non-flammable gases, or mixtures thereof; and
the gases include air, a non-flammable gas, or any mixture thereof.

15. The apparatus of claim 10, wherein the scavengers or scavenging agents include sulfur scavengers or scavenging agents, hydrogen cyanide scavengers or scavenging agents, carbon dioxide scavengers or scavenging agents, any other scavengers or scavenging agents used to clean hydrocarbon gases such as methane, natural gas, or propane.

16. The apparatus of claim 15, wherein:
the flammable vapors include methane, contaminated methane, natural gas, contaminated natural gas, sour natural gas, ethane, contaminated ethane, propane, contaminated propane, other hydrocarbon fuels, or other contaminated hydrocarbon fuels;
the adjustment gases include hydrocarbon gases, gaseous hydrocarbon fuels, other flammable gases, non-flammable gases, or mixtures thereof;
for non-flammable vapors, the adjustment gases are designed to adjust the composition of the non-flammable vapor prior to subsequent use; and
the gases include air, a non-flammable gas, or any mixture thereof.

17. The apparatus of claim 16, wherein:
the flammable vapors for use in this disclosure include, without limitation, methane, natural gas, ethane, propane, gasoline, diesel, or other hydrocarbon fuels;
the adjustment gases for use in this disclosure include, without limitation, methane, natural gas, ethane, propane, or mixtures thereof; and
the non-flammable gas includes nitrogen, carbon dioxide, argon, a freon, any other non-flammable gas, or mixtures thereof.

18. The apparatus of claim 10, wherein:
the liquid pumps include axial type liquid pumps, mixed type liquid pumps, radial type liquid pumps, electromagnetic type liquid pumps, jet type liquid pumps, gear type liquid pumps, peristaltic type liquid pumps, rotary vane type liquid pumps, screw type liquid pumps, diaphragm type liquid pumps, piston/plunger type liquid pumps, or any other type pump capable pumping a liquid;
the liquid flow control valves include ball valves, butterfly valves, gate valves, globe valves, diaphragm valves, piston valves, any other type of flow control valve for controlling a liquid flow rate, or combinations thereof; and
the gas flow control valves for use in this disclosure include, without limitation, ball valves, butterfly valves, gate valves, globe valves, diaphragm valves, piston valves, any other type of flow control valve for controlling a gas flow rate, or combinations thereof.

19. The apparatus of claim 10, wherein:
the pressure sensors include aneroid barometer pressure sensors, manometer pressure sensors, bourdon tube pressure sensors, vacuum pressure sensors, sealed pressure sensors, piezoelectric pressure sensors, strain gauge pressure sensors, or any combination thereof;
the temperature sensors include thermocouple devices, resistance temperature detection devices, thermistor devices, semiconductor based IC devices, or any combination thereof;
the composition sensors include potentiometric sensors, amperometric sensors, impedimetric sensors, or any combination thereof;
the BTU sensors include mechanical heat meter sensors, heat meter using ultrasound sensors, electrical heat meter sensors, electrochemical gas sensor, catalytic gas sensor, infrared gas sensor, photoionization gas sensor. or any combination thereof; and
the liquid and/or gas level sensors include air bubbler level sensors, capacitive level sensors, differential pressure level sensors, electrical conductivity or resistance level sensors, mechanical or magnetic float level sensors, optical level sensors, pressure membrane level sensors, radar or microwave level sensors, radio frequency (RF) level sensors, sonic or ultrasonic level sensors, retractable tape level sensors, Hi-Hi switch level sensors, tuning fork level sensors, any other level sensor, or any combination thereof.

20. A method comprising:
installing an integrated vapor concentration adjustment and treatment apparatus or system into a tank of a vapor storage assembly or subsystem,
installing an integrated vapor treating control assembly,
filling a lower section of the tank with a liquid from a liquid source;
filling a vapor storage tank of a vapor storage assembly with a vapor from a vapor source;
as the vapor storage tank is being filled with the vapor, simultaneously adjusting a gas storage assembly disposed in an interior of the vapor storage tank;
withdrawing the liquid from the lower section of the vapor storage tank;
injecting the withdrawn liquid into the vapor in the vapor storage tank, simultaneously or sequentially injecting an adjustment gas from an adjustment gas source into the vapor storage tank, and optionally simultaneously or sequentially injecting one or more vapor purifying materials from a vapor purifying material source into the vapor storage tank to form an output vapor having a desired output vapor composition; and
supplying the output vapor cither to an abatement or incineration assembly or subsystem at a controlled pressure and flow rate or to a pipeline introduction and sensor assembly at a controlled temperature, pressure, and flow rate.
